(19) United States
(12) Patent Application Publication
(10) Pub. No.: US 2025/0338168 A1
(43) Pub. Date: Oct. 30, 2025

(54) RADIO NETWORK NODE, USER EQUIPMENT, AND METHODS PERFORMED THEREIN

(71) Applicant: Telefonaktiebolaget LM Ericsson (publ), Stockholm (SE)

(72) Inventors: Henning WIEMANN, Aachen (DE); Seungtai KIM, Solna (SE); Göran RUNE, Linköping (SE); Torsten DUDDA, Wassenberg (DE)

(21) Appl. No.: 18/870,713

(22) PCT Filed: Jun. 3, 2022
(86) PCT No.: PCT/SE2022/050548

§ 371 Date: Dec. 2, 2024

(51) Int. Cl. H04W 28/02; H04J 3/06; H04W 72/044

(52) U.S. Cl. CPC H04W 28/0278; H04J 3/0661; H04W 72/044

(57) ABSTRACT

A method performed by a radio network node for communicating with a user equipment (UE) in a wireless communications network. The method includes receiving a buffer status report (BSR) from the UE, the BSR indicating a current amount of data buffered in an uplink (UL) buffer of the UE for a logical channel or a logical channel group. The method includes determining whether to update an age map for the logical channel of the radio network node by determining a difference between the current amount of data indicated in the BSR message and a sum of data values stored in the age map. The age map is also updated when data is received from the UE in accordance with a UL grant. The BSR may be extended to include both the amount of data in the UL buffer and an age of the oldest data in the UL buffer.

### TECHNICAL FIELD

Embodiments herein relate to a radio network node, a user equipment (UE), and methods performed therein regarding wireless communication. Furthermore, a computer program product and a computer readable storage medium are also provided herein. In particular, embodiments herein relate to handling communications in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

In wireless communication systems, an UL is a transmission path from a user equipment to a radio network node, such as a base station, and a DL is a transmission path from the base station to the user equipment.

If some data arrives at the UE side, the UL scheduling process is as follows. First, the UE sends the Schedule Request (SR) message to a radio network node, such as a gNB, over the Physical Uplink Control Channel (PUCCH). The UE informs the radio network node via the SR whether uplink resources are needed for the Uplink Shared Channel (UL-SCH) transmission, but it does not tell the radio network node the volume of data that needs to be sent, which is reported via a Buffer Status Report (BSR). After the radio network node receives the SR message, it sends the UL grant, in a Downlink Control Information, over a Physical Downlink Control Channel (PDCCH), to the UE. Since the radio network node does not know the volume of data at the UE, the amount of uplink resources allocated to the UE in the UL grant depends on the implementation of the radio network node, and is usually at least enough resources for the UE to send the BSR. Subsequently, the UE needs to inform the radio network node about the amount of data in its UL buffer that is waiting to be sent. Based on the received BSR, the radio network node can decide how much and what UL resources to allocate to the UE. Once the grant from the radio network node is received, the data in the UE's UL buffer can be sent.

In both Long Term Evolution (LTE) and NR standards, a UE sends a BSR to a radio network node, such as a base station, e.g., gNB, if data becomes ready for transmission when a UE buffer was previously empty, or if data becomes ready for transmission on a logical channel with a higher priority than the UE buffer were previously storing. The UE may also send the BSR if a timer expires while data are waiting for transmission. Also, if the UE does not have a valid UL grant, instead of a BSR, the UE sends a Dedicated Scheduling Request (D-SR) over the PUCCH. The arrival of a D-SR informs the radio network node that the UE has data available for UL transmission, although the D-SR does not tell the radio network node how much data the UE has.

The BSR is a type of a Media Access Control (MAC) control element (CE) message that includes information about the amount of data that is pending for UL transmission in the UE buffer, i.e., the data available on the Data Link layer in the UE for transmission. A BSR may comprise size of buffers associated with logical channels of one or more logical channel groups (LCGs). Based on the BSR received from the connected UE, the radio network node, such as a gNB or eNB, allocates UL resources, also referred to as UL grant, to the UE. The radio network node thus uses information in the BSR to determine which UEs to schedule in which order, as well as an amount of radio resources and a modulation and coding scheme (MCS) to use for that transmission.

The information about the pending amount of data is considered sufficient for regular mobile broadband (MBB) traffic where the radio network node, such as a gNB, typically attempts to maximize the UL throughput and to ensure some fairness among UEs.

However, for time-critical communications, such as, e.g., a real time application, streaming of video or instructions regarding controlling a vehicle, communications during a surgery or similar, the radio network node, such as a gNB, is usually required to transmit data packets within a given delay budget. For downlink packets, the gNB can time-stamp packets that arrive via the NG user plane (NG-U) interface and then determine their urgency based on the time that has elapsed since their arrival. For example, a known scheduling strategy is to increase the packets' scheduling priority with their queuing delay or when their queuing delay approaches their delay budget.

### SUMMARY

The BSRs sent by the UE's MAC layer include information about an amount of data in a UE's UL buffer(s), but lack information about a queuing delay of packets in the UL buffer. A D-SR informs the radio network node that the UE has data available for UL transmission but does not specify the amount of that data. Accordingly, there is a need for improved techniques related to BSRs, so that a radio network node can more efficiently manage resource allocation for UL data transmission by the UE.

Accordingly, an object herein is to provide a technique that allows efficient allocation of UL grants by a radio network node, such as a gNB, to a UE in a wireless communications network. A method is provided herein in which a radio network node relies on its own timing to keep track of data that is reported to be available for transmission by a UE, as reported by a BSR, or a BSR message, received by the radio network node from the UE.

Aspects of the present disclosure provide a method performed by a radio network node such as, e.g., a gNB, that uses information in a BSR to maintain a data structure referred to as an age map, which allows keeping track of information in a UL buffer of a UE connected to the radio network node. The age map may be updated upon arrival of a BSR, upon reception of UL data from the UE, and upon transmission of UL grants by the radio network node to the UE. In this way, the radio network node estimates an age of packets in the UL buffer and may therefore allocate resources to the UE for UL data transmission in a more efficient manner, while taking into consideration packets' priority and urgency.

According to an aspect, the object is achieved, according to embodiments herein, by providing a method performed by a radio network node for communication with a UE. The method comprises receiving a BSR message from the UE, the BSR message indicating a current amount of data buffered in a UL buffer of the UE for a logical channel. The method further comprises determining whether to update an age map for the logical channel of the radio network node by determining a difference between the current amount of data indicated in the BSR message and a sum of data values stored in the age map for the logical channel of the radio network node, wherein each entry in the age map includes a data value and an associated timestamp, the associated timestamp indicating an estimated arrival time of data corresponding to the data value to the UL buffer. The method further comprises, with the proviso that the difference is a positive value, adding a new entry to the age map, the new entry having a timestamp corresponding to a time of receipt of the BSR message and a data value corresponding to the difference; and using the age map to determine resources for data transmission from the UL buffer to the radio network node and indicating the determined resources to the UE.

According to an aspect the object is achieved, according to embodiments herein, by providing a radio network node configured for communication with a UE, in a wireless communications network. The radio network node is configured to receive a BSR message from the UE, the BSR message indicating a current amount of data buffered in an UL buffer of the UE for a logical channel. The radio network node is further configured to determine whether to update an age map for the logical channel of the radio network node by determining a difference between the current amount of data indicated in the BSR message and a sum of data values stored in an age map for the logical channel of the radio network node, wherein each entry in the age map includes a data value and an associated timestamp, the associated timestamp indicating an estimated arrival time of data corresponding to the data value to the UL buffer. The radio network node is further configured to, with the proviso that the difference is a positive value, add a new entry to the age map, the new entry having a timestamp corresponding to a time of receipt of the BSR message and a data value corresponding to the difference; and use the age map to determine resources for data transmission from the UL buffer to the radio network node and indicate the determined resources to the UE.

It is furthermore provided herein a computer program product comprising instructions, which, when executed on at least one processor, cause the at least one processor to carry out the method above, as performed by the radio network node. It is also provided herein a computer-readable storage medium, having stored thereon a computer program product comprising instructions which, when executed on at least one processor, cause the at least one processor to carry out the method according to the method above, as performed by the radio network node.

Aspects of the present disclosure also provide an extended BSR that is transmitted by a UE to a radio network node such as, e.g., gNB. The BSR is extended to explicitly indicate, in addition to an amount of data in the UL buffer, how long time ago the data indicated in the BSR report, as the amount of data in the UL buffer, entered the UL buffer of the UE. The BSR message may thus indicate a time from an entry time when data indicated by the current amount of data in the BSR message entered the UL buffer of the UE until a transmission time when the BSR message is transmitted by the UE. The BSR message indicates a time when the oldest queued data entered the UL buffer of the UE.

According to an aspect the object is achieved, according to embodiments herein, by providing a method performed by a UE for communication with a radio network node in a wireless communications network. The method comprises storing, in a UL buffer of the UE, data for transmission to the radio network node; transmitting a BSR message to the radio network node, the BSR message indicating an amount of data in the UL buffer and a time from an entry time when data indicated by the amount of data in the BSR message entered the UL buffer of the UE until a transmission time when the BSR message is transmitted by the UE; and receiving, from the radio network node, an indication of resources determined for data transmission from the UL buffer to the radio network node, wherein the resources are determined using information in the BSR message.

According to another aspect the object is achieved, according to embodiments herein, by providing a method performed by a radio network node for communication with a UE in a wireless communications network. The method comprises receiving a BSR message from the UE, the BSR message indicating an amount of data in a UL buffer of the UE and a time from an entry time when data indicated by the amount of data in the BSR message entered the UL buffer of the UE until a transmission time when the BSR message is transmitted by the UE; determining resources for data transmission from the UL buffer of the UE to the radio network node, wherein the resources are determined using information in the BSR message; and providing to the UE an indication of the determined resources.

According to an aspect the object is achieved, according to embodiments herein, by providing a UE and a radio network node configured to perform the methods herein, respectively.

It is furthermore provided herein a computer program product comprising instructions, which, when executed on at least one processor, cause the at least one processor to carry out the method above, as performed by the UE or the radio network node, respectively. It is also provided herein a computer-readable storage medium, having stored thereon a computer program product comprising instructions which, when executed on at least one processor, cause the at least one processor to carry out the method according to the method above, as performed by the UE or the radio network node, respectively.

According to another aspect the object is achieved, according to embodiments herein, by providing a UE configured for communication with a radio network node (12) in a wireless communications network. The UE is configured to: store, in a UL buffer of the UE, data for transmission to the radio network node; transmit a BSR message to the radio network node, the BSR message indicating an amount of data in the UL buffer and a time from an entry time when data indicated by the amount of data in the BSR message entered the UL buffer of the UE until a transmission time when the BSR message is transmitted by the UE; and receive, from the radio network node, an indication of resources determined for data transmission from the UL buffer to the radio network node, wherein the resources are determined using information in the BSR message.

According to another aspect the object is achieved, according to embodiments herein, by providing a radio network node configured for communication with a UE in a wireless communications network. The radio network node is configured to: receive a BSR message from the UE, the BSR message indicating an amount of data in a UL buffer of the UE and a time from an entry time when data indicated by the amount of data in the BSR message entered the UL buffer of the UE until a transmission time when the BSR message is transmitted by the UE; determine resources for data transmission from the UL buffer of the UE to the radio network node, wherein the resources are determined using information in the BSR message; and provide to the UE an indication of the determined resources.

Embodiments herein disclose techniques for the radio network node to keep track of a status of a UL buffer of the UE, such that the radio network node allocates resources for UL transmission of data in the UL buffer in an efficient manner. Furthermore, embodiments herein also provide a BSR that is extended to indicate a time from an entry time when data indicated by the amount of data in the BSR message entered the UL buffer of the UE until a transmission time when the BSR message is transmitted by the UE. The BSR may include an additional field having the time indicated in the BSR. The additional field may indicate an age of oldest data, e.g., an oldest packet, in the UL buffer of the UE. The techniques described herein may result in an improved allocation, by the radio network node, of resources for UL data transmission by the UE, thereby improving the overall performance of the wireless communications network.

### BRIEF DESCRIPTION OF THE DRAWINGS

Embodiments will now be described in more detail in relation to the enclosed drawings, in which:

FIG. 1 is a diagram depicting a wireless communications network according to embodiments herein;

FIG. 2 is a combined signalling scheme and flowchart depicting embodiments herein;

FIGS. 3A and 3B are flowcharts illustrating a method performed by a radio network node according to embodiments herein;

FIGS. 4A, 4B, 4C, 4D, and 4E show examples of maintaining and updating an age map in a method performed by a radio network node, according to embodiments herein;

FIG. 5 is a combined signalling scheme and flowchart depicting embodiments herein;

FIG. 6 is a flowchart illustrating a method performed by a UE according to some embodiments herein;

FIG. 7 is a flowchart illustrating a method performed by a radio network node according to some embodiments herein;

FIG. 8 is a block diagram depicting embodiments of a radio network node according to embodiments herein;

FIG. 9 is a block diagram depicting embodiments of a UE according to embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12, 13, 14, and 15 are flowcharts illustrating methods implemented in a communication system including a host computer, a base station and a user equipment.

### DETAILED DESCRIPTION

In 3GPP, a BSR, also referred to herein as a BSR message, includes information on an amount of data buffered in a UL buffer of the UE for a logical channel or a logical channel group, for transmission to a radio network node, e.g., a gNB. The radio network node uses the information in the BSR to allocate a UL grant to the UE, so that data available for transmission at the UE can be sent to the radio network node. The radio network node is however not aware of a time of when certain data was stored in the UE's UL buffer, which may complicate allocating of resources for and scheduling UL transmission of data stored at the UE. A radio network node, such as a gNB, may be connected to multiple UEs and it uses information in BSR messages received from the UEs to determine which UEs to schedule in which order, as well as an amount of radio resources and a modulation and coding scheme (MCS) to use for that transmission. As discussed above, for time-critical communication, the gNB is usually required to transmit data packets within a given delay budget, i.e., within a maximum allowable period of time. While the gNB has the necessary information to perform delay-based scheduling and link adaptation for downlink (DL) data, it lacks information about packets queued for UL transmission at the UE. The BSR message, sent by a UE's MAC layer, does not include information about timing, e.g., a queueing delay, of packets in the UE's UL buffer.

Accordingly, aspects of the present disclosure provide a technique that allows the radio network node to keep track of data, such as packets, queued in UL buffer(s) of the UE. In particular, the radio network node maintains a data structure, referred to as an age map of a UE's UL buffer, which associates one or more portions of data, such as a number of bits or bytes, with a timestamp of an estimated arrival time of the portion(s) in the UE's UL buffer. The radio network node determines a difference between the amount of data that the UE reports for one logical channel or group in a BSR and the amount of data associated with all previously stored entries in the age map for that logical channel or group. If the difference is positive, which indicates that the UE has reported new data, the radio network node associates that amount of (new) data with a new timestamp and stores it as a new entry in the age map. If the difference is negative, i.e. the UE has reported less data than the radio network node expected (e.g. due to granularity of the BSR message or due to dropping of data at UE side), the radio network node modifies the age map to account for this change at the UE. The radio network node may modify the age map by subtracting the amount of data corresponding to the difference, which is negative in this case, from the stored entries in the age map, which may be one or more entries with an oldest timestamp or one or more entries with a newest timestamp. When the radio network node receives data from the UE, for the logical channel for which the age map is maintained, the radio network node subtracts that amount of data from the stored entries in the age map, starting with an entry with the oldest timestamp. In another alternative, the radio network node subtracts the amount of data already when it sends a grant to the UE, i.e., when allocating radio resources. In this way, the radio network node may avoid allocating data multiple times for the same entry in the age map while waiting for the transmission (and a BSR message) from the UE in response to a first grant.

Furthermore, in some aspects, in addition to maintaining an age map, or independently thereof, a BSR is extended with information on when data entered the UL buffer of the UE, e.g., indicating how long time ago the data entered the UL buffer relative to the BSR. The BSR may be extended by a field indicating an age of the oldest data, e.g., packet(s), in the UL buffer of the UE, per logical channel or logical channel group, i.e., for the oldest packet in a UL buffer for the respective logical channel or logical channel group.

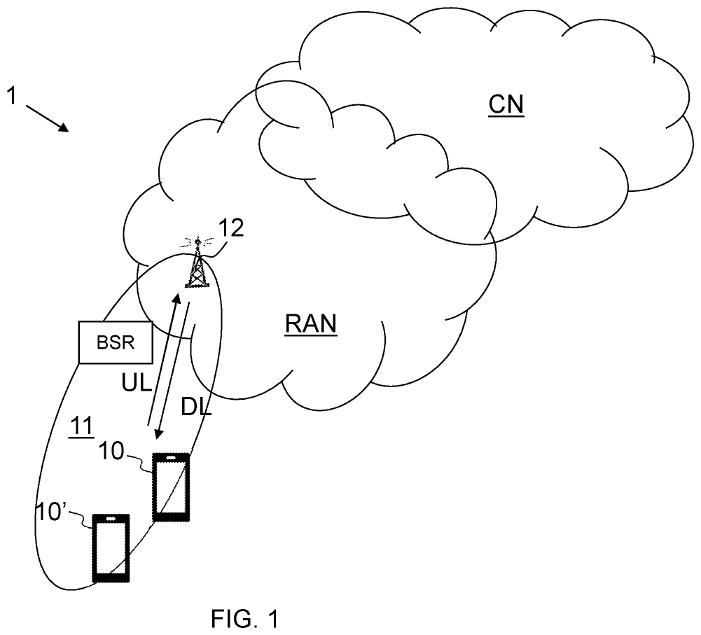

Embodiments herein relate to wireless communications networks in general. FIG. 1 is a schematic overview depicting a wireless communications network 1. The wireless communications network 1 comprises one or more RANs and one or more CNs. The wireless communications network 100 may use a number of different technologies, such as mmWave communication networks, Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context and/or a 6G context, however, embodiments are also applicable in further development of the existing wireless communication systems such as e.g. WCDMA and LTE.

A number of mobile devices operate in the wireless communications network 1, such as, e.g., a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). As shown in FIG. 1, the wireless communications network 1 may also include a user equipment (UE) 10′ which is similar to UE 10. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

A number of network nodes operate in the wireless communications network 1 such as e.g., a radio network node 12. The network node 12 provides providing radio coverage over a geographical area, a service area 11 or cell, of a radio access technology (RAT), such as NR, LTE, or similar. The service area may be denoted as cell, beam, beam group, or similar to define an area of radio coverage.

The radio network node 12 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with mobile devices such as e.g. UEs 10 and 10′ in the service area 11, or in respective different service areas, served by the radio network node 12 depending e.g. on the radio access technology and terminology used. The radio network node may be referred to as a serving radio network node wherein the service area may be referred to as a serving cell, and the serving network node communicates with the wireless device in form of DL transmissions to the wireless device and UL transmissions from the wireless device.

As shown in FIG. 1, the radio network node 12 communicates with mobile devices such as the UEs 10 and 10′, in DL transmissions to the mobile devices and UL transmissions from the mobile devices. As shown schematically in FIG. 1, a UE, such as the UE 10, may send a BSR to the radio network node 12. The UE 10′ may similarly send a BSR to the radio network node 12.

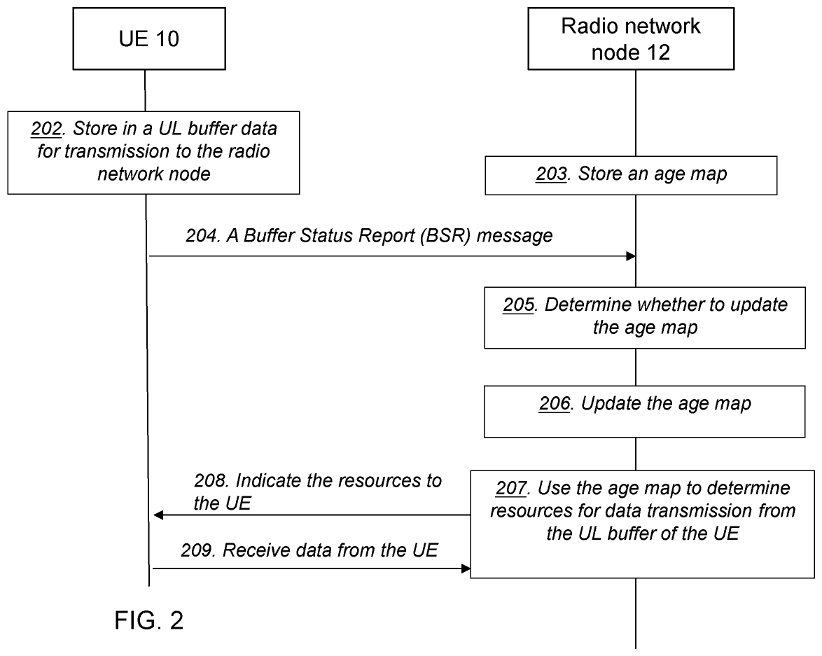

FIG. 2 is a combined signalling scheme and flowchart depicting embodiments herein. FIG. 2 is described in connection with the UE 10 and the radio network node 12 by way of example, as the UE 10′ or another UE may communicate with the radio network node 12 in accordance with embodiments of the present disclosure.

The process shown in FIG. 2 comprises the following actions, which actions may be taken in any suitable order.

Action 202. The UE 10 stores in a UL buffer data for transmission to the radio network node 12.

Action 203. The radio network node 12 stores an age map for keeping track of entries in the UL buffer of the UE 10. The age map may be created, for a logical channel or more than one logical channels, i.e. for a logical channel group, when data becomes available for transmission for that logical channel or group. Each entry in the age map includes a data value and an associated timestamp, the associated timestamp indicating an estimated arrival time of data corresponding to the data value to the UL buffer of the UE. Thus, each entry is represented by a pair comprising a data value, such as a number of bytes or bits, and a timestamp associated with that data value. The estimated arrival time may be a time of receipt of a corresponding BSR message, such as the BSR message in which the data value was reported to the radio network node 12 by the UE 10. It should be noted however that the data value in an entry in the age map may be updated, e.g., based on subsequent BSR messages and/or UL grants, such that it differs from the initial data value that was stored in that entry upon a creation of the entry.

In some embodiments, the estimated arrival time indicated in the associated timestamp of an entry in the age map may be a time of receipt of a corresponding BSR message minus an offset accounting for a time from an arrival to the UL buffer of the UE of data corresponding to that entry until the time of receipt of the BSR message. In other words, the estimated arrival time indicated in the associated timestamp of an entry in the age map may account for how long the data reported in the BSR message was stored in the UL buffer of the UE before the BSR message was sent and received by the radio network node 12.

In some embodiments, the estimated arrival time indicated in the associated timestamp of an entry in the age map may be a due time for the UE to transmit the data indicated in the entry having the corresponding timestamp.

Action 204. The UE 10 transmits a BSR message to the radio network node 12. The BSR message indicates a current amount of data buffered in a UL buffer of the UE for a logical channel. The BSR message may include information on a current amount of data buffered in a UL buffer of the UE for a logical channel group.

In some implementations, the BSR message indicates a time from an entry time when data indicated by the current amount of data in the BSR message entered the UL buffer of the UE until a transmission time when the BSR message is transmitted by the UE. The time indication additionally included in the BSR message indicates for how long the data, e.g., one or more packets, has been stored in the UL buffer of the UE. In some embodiments, the BSR message includes an additional field indicating the time. The time may comprise an age of oldest data, e.g., an oldest packet, in the UL buffer of the UE. Accordingly, in some implementations, the BSR message may be extended to explicitly indicate additional information on queuing delay of packets in the UE's UL buffer, which allows efficiently managing UL data transmission. For example, when the BSR message additionally includes the age of the oldest packet in the UL buffer in the UE, the radio network node 12 may replace a timestamp of an oldest entry in the age map with the age of the oldest packet included in the BSR message.

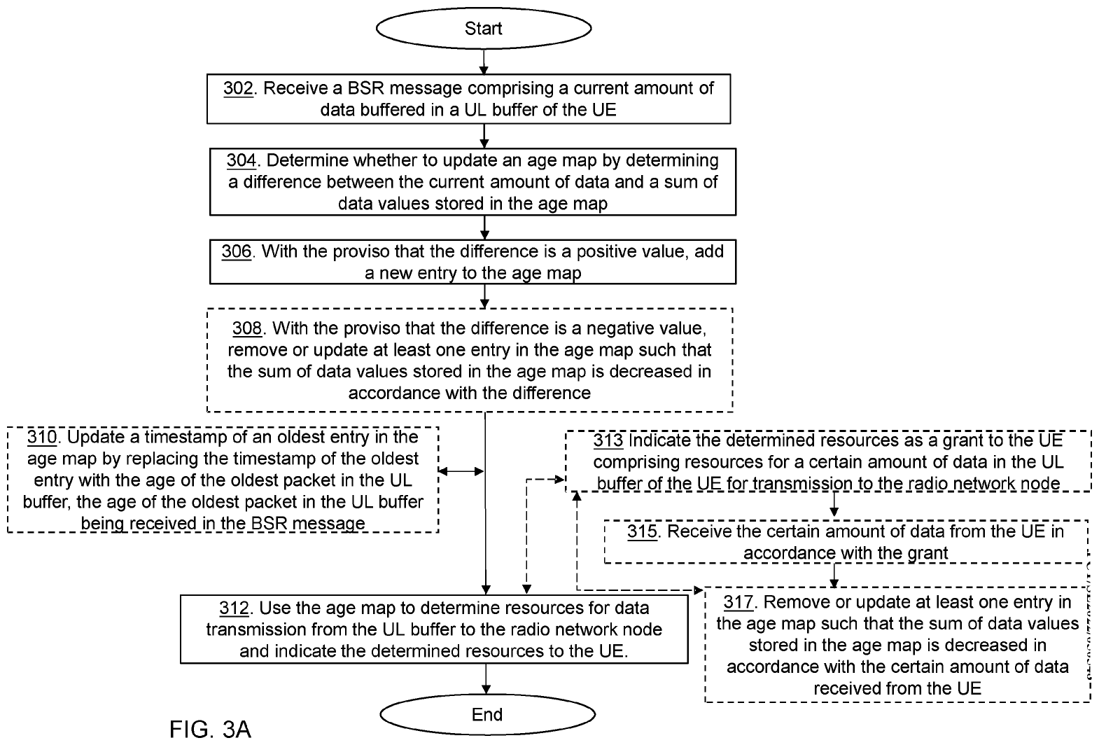

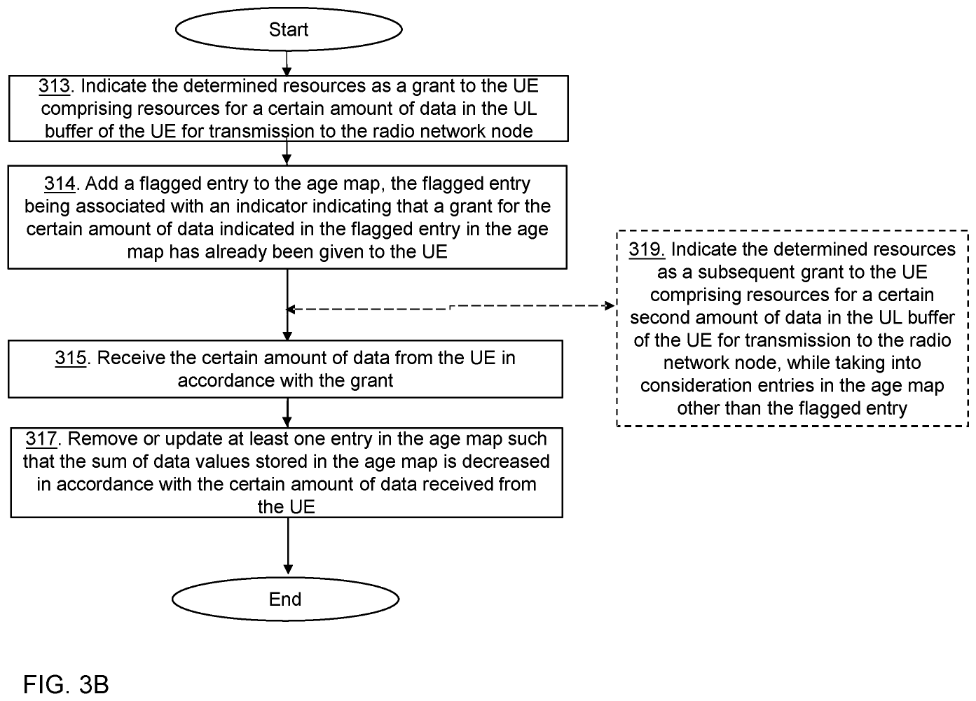

Action 205. The radio network node 12 receives the BSR message, decodes it, and determines whether to update the age map that the radio network node 12 stores for keeping track of entries in the UL buffer of the UE 10. The radio network node 12 determines whether to update an age map for the logical channel of the radio network node by determining a difference between the current amount of data indicated in the BSR message and a sum of data values stored in the age map for the logical channel of the radio network node, as discussed in more detail in connection with FIG. 3. Each data value is stored in the age map in a respective entry, in association with an associated timestamp.

Action 206. The radio network node 12 may update the age map, as discussed in more detail below. For example, with the proviso that the difference between the current amount of data indicated in the BSR message and the sum of data values stored in the age map is a positive value, the radio network node 12 adds a new entry to the age map, the new entry having a timestamp corresponding to a time of receipt of the BSR message and a data value corresponding to the difference. Furthermore, with the proviso that the difference is a negative value, the radio network node 12 may remove or update at least one entry in the age map such that the sum of data values stored in the age map is decreased in accordance with the difference, i.e, in accordance with the magnitude of the difference. With the proviso that the difference is zero, indicating that no changes are reported, the age map is not updated. If no more data is associated with a timestamp in an entry of the age map, that timestamp and associated data value, as a pair, are removed from the age map.

Action 207. The radio network node 12 uses the age map to determine resources for data transmission from the UL buffer to the radio network node.

Action 208. The radio network node 12 indicates the determined resources to the UE 10. For example, the radio network node 12 may transmit an indication, such as a UL grant, to the UE regarding resources for data transmission from the UL buffer of the UE 10 to the radio network node. The radio network node 12 thus allocates resources, in the form of a UL grant, to the UE 10 based on information in the age map. Because the radio network node 12 keeps track of a timing data associated with data available for UL transmission by the UE 10, and may thus keep track of age of the data, the radio network node 12 may prioritize resource allocation in an improved manner, which leads to improved efficiency of communications between the UE 10 and the radio network node 12.

In some cases, a subsequent BSR is sent, e.g., as a MAC Protocol Data Unit (PDU), together with the data which is sent in accordance with the given (prior) UL grant. Thus, the BSR reflects the amount of data in the UE's UL buffer, or queue, after dequeuing the data in the current MAC PDU.

Action 209. The radio network node 12 receives data from the UE 10. For example, the radio network node 12 may receive data from the UE 10 in accordance with the UL grant that the UE 10 has received from the radio network node 12.

FIG. 3A is a flowchart illustrating a method performed by a radio network node 12, according to embodiments herein. The radio network node 12 may store in its memory, which may be a remote storage, an age map in accordance with the present disclosure. The age map may be created and stored for a logical channel or a logical channel group. The method in FIG. 3A is described in connection with the radio network node 12 and the UE 10, but the radio network node 12 may communicate in a similar manner, according to embodiments herein, with the UE 10′ or any other UE.

The method comprises the following actions, which actions may be taken in any suitable order. Optional actions are referred to as dashed boxes in FIG. 3A.

Action 302. The radio network node 12 receives a BSR message from the UE 10, the BSR message indicating a current amount of data buffered in a UL buffer of the UE 10 for a logical channel. The BSR message may indicate a current amount of data buffered in the UL buffer of the UE for a logical channel group which may comprise one or more logical channels.

In some embodiments, as also discussed in detail below, the BSR message may be extended to include further information, in addition to the current amount of data buffered in a UL buffer of the UE for a logical channel or a logical channel group.

In some embodiments, the BSR message may be extended to further indicate a time from an entry time when data indicated by the current amount of data in the BSR message entered the UL buffer of the UE until a transmission time when the BSR message is transmitted by the UE. The time from the entry time until the BSR transmission time may be an age of the oldest entry or packet in the UL buffer of the UE. The BSR message may include an additional field indicating the time. The indicated time may comprise an age of oldest data, e.g., an oldest packet, in the UL buffer of the UE. The age of the oldest packet in the UL buffer of the UE may be indicated in the additional field of the BSR message as a system frame number (SFN) of a time at which the oldest packet arrived in the UL buffer of the UE. In such cases, the additional field of BSR message may include a certain number of least significant bits of the SFN that is smaller than a number of all bits of the SFN.

The time indicated in the BSR message, such as a time from an entry time when data indicated by the current amount of data in the BSR message entered the UL buffer of the UE until a transmission time of the BSR message, e.g., an age of the oldest packet in the UL buffer, may be derived, at the UE 10, in various ways. For example, the time indicated in the BSR message may be derived from a packet arrival on a chip set or modem level of the UE. For example, the UE 10 may store the current system time at which a data packet arrived in the UE. In some examples, the “arrival time” may be provided and passed to the chipset or modem by the application that generated the data and may thereby allow to determine the actual age of the data more accurately. Upon generating a BSR, the UE computes the difference between the (new) current system time and the stored arrival time of the oldest queued packet and includes this difference into the BSR. The determined time difference may be rounded or quantized in a predetermined way (e.g. finer granularity for smaller latency values than for larger latency values) to require fewer bits in the BSR message.

In some cases, instead of reporting the age of the packet (i.e. a difference between packet arrival and transmission of the BSR) in the BSR, the UE 10 may include an absolute time in the BSR. This may be the time when the packet arrived on chipset or modem level or when the application generated it. Alternatively, it may be the “due time”, i.e., the latest time by which the UE should have transmitted the data to meet the packets Quality of Service (QOS) requirements. An absolute time stamp may be defined as a global time such as Coordinated Universal Time (UTC) or the system time of the radio interface. The latter may be a system frame number (SFN), or a slot number, or a combination of both. To reduce the required number of bits in the BSR, the time format may be truncated such that the least and/or most significant bits of the UTC, SFN/slot-number are not transmitted in the BSR.

In some embodiments, the BSR message may further indicate an amount of data that was dropped from the UL buffer of the UE compared to a time of transmittal of a prior BSR message. In other words, the BSR message may explicitly indicate how much data was dropped from the UL buffer as compared to a time when the prior BSR message was transmitted by the UE. However, in some implementations, the amount of data dropped from the UL buffer is determined using a current BSR reporting a smaller UL buffer size as compared to a prior BSR, with possible intermediate UL grants. Thus, the radio network node 12 may determine that this data vanished. This may be either due to different granularity of the BSR report (e.g., finer for small buffer sizes) or due to that the UE dropped data in the meantime.

The BSR message may be reported via the BSR MAC Control Element in the MAC layer of the UE. Based on the length, two formats of BSRs may be defined, the short BSR and long BSR. Depending on a process that triggers a BSR message, the BSRs can be divided into three types, the regular BSR, padding BSR, and periodic BSR. It should be appreciated that aspects of the present disclosure are not limited to any specific BSR format or to an event that triggers the BSR. Accordingly, the radio network node may update an age map, created per a logical channel or a logical channel group for a UE, upon receiving any type of a BSR.

In some aspects, an age of the oldest data, e.g., packet(s), in a UL buffer of the UE may be indicated in a BSR of a long format. However, a BSR having a short format, or another format, may indicate both a current amount of data in a UL buffer of the UL and the age of the oldest packet in that UL buffer. A short BSR/truncated BSR may be a 1-byte MAC CE, and it may require two bytes (including 1-byte subheader), plus the age of the oldest data in the UE's UL buffer per a logical channel or a logical channel group, for reporting using this format. A long BSR may require 4-bytes (3-bytes of Long BSR MAC CE+1-byte subheader), plus the age of the oldest data in the UE's UL buffer per a logical channel or a logical channel group. The age of the oldest data in the UE's UL buffer may be included as a field, e.g., a field which may be referred to as an age field, in a BSR message. A BSR in accordance with aspects of the present disclosure may have any suitable number of bits in the age field, e.g., 1 bit, or 2 bits, or 3 bits, or 4 bits, or 5 bits, or 6 bits, or 7 bits, or 8 bits, or more than 8 bits. The aspects of the present disclosure are not limited to any specific granularity and range of a BSR message including, e.g., in an age field, the age of the oldest data, e.g., packet(s), in the UL buffer of the UE in accordance with aspects of the present disclosure.

Action 304. The radio network node 12 determines whether to update an age map for the logical channel of the radio network node by determining a difference between the current amount of data indicated in the BSR message and a sum of data values stored in the age map for the logical channel of the radio network node, wherein each entry in the age map includes a data value and an associated timestamp, the associated timestamp indicating an estimated arrival time of data corresponding to the data value to the UL buffer of the UE 10. The data value thus indicates an amount of data that is expected to be stored in the UL buffer of the UE 10 at a time indicated by the timestamp. It should be appreciated that the age map is an estimate of what data has been stored, and when, in the UL buffer of the UE 10. The radio network node 12 thus keeps track of the data queued for UL transmission in the UL buffer using information obtained from the BSR messages from the UE 10 and timestamps assigned by the radio network node 12 to data values in the BSR message. The actual data in the UL buffer of the UE 10 may however differ from what the radio network node 12 expects to be in the UL buffer, according to the age map.

As mentioned above, the associated timestamp in an entry in the age map indicates an estimated arrival time to the UL buffer of the UE 10 of data corresponding to a data value associated with that timestamp. The data value and the timestamp form a pair, such that the age map has one or more data value/timestamp pairs.

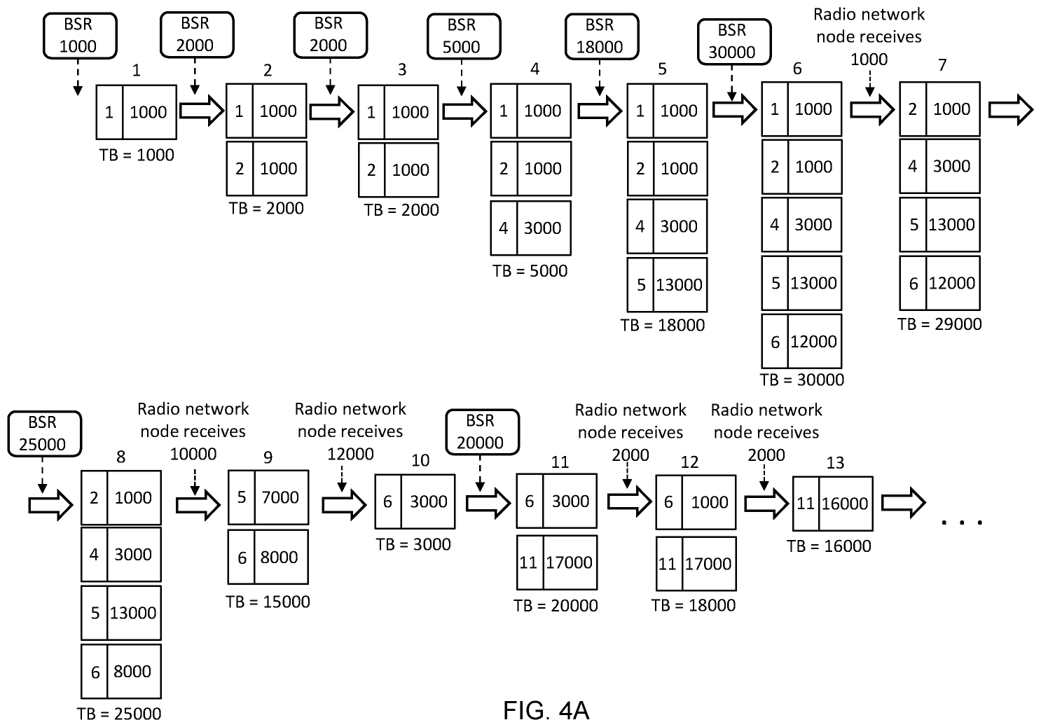

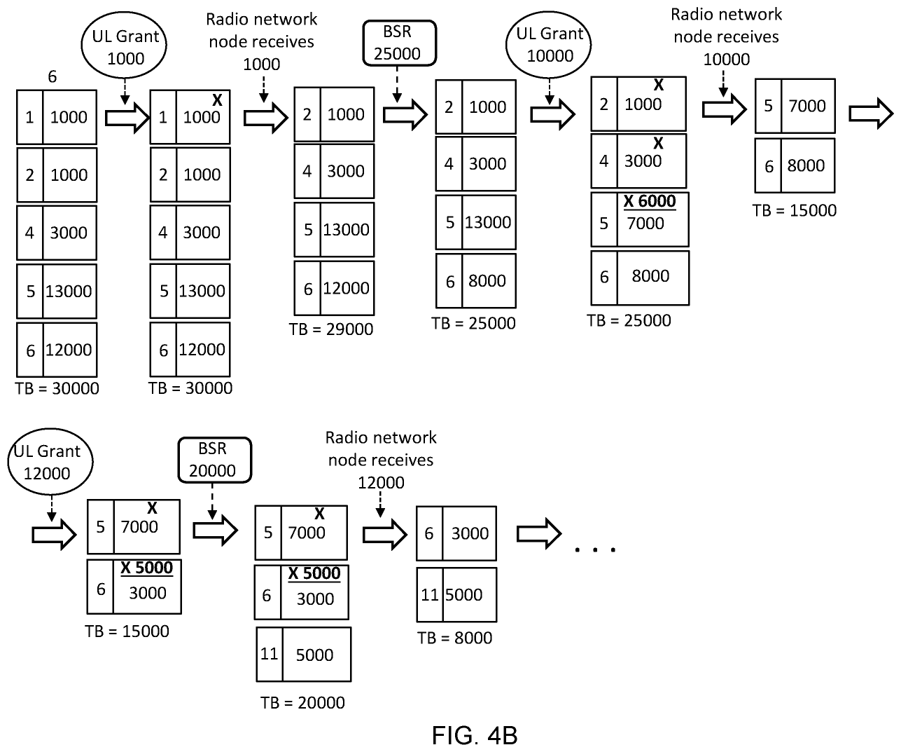

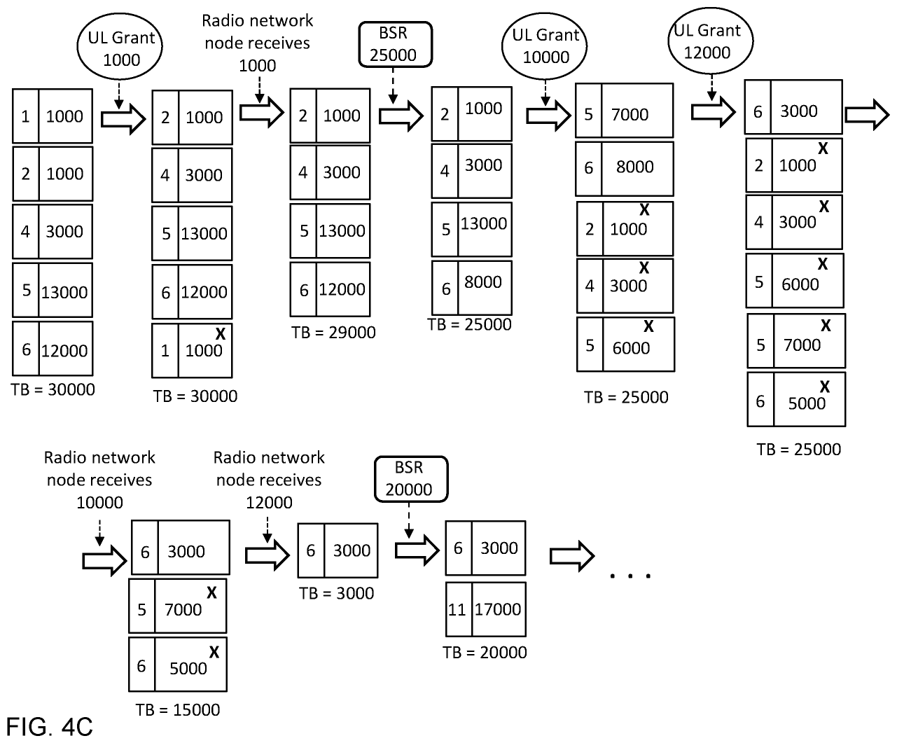

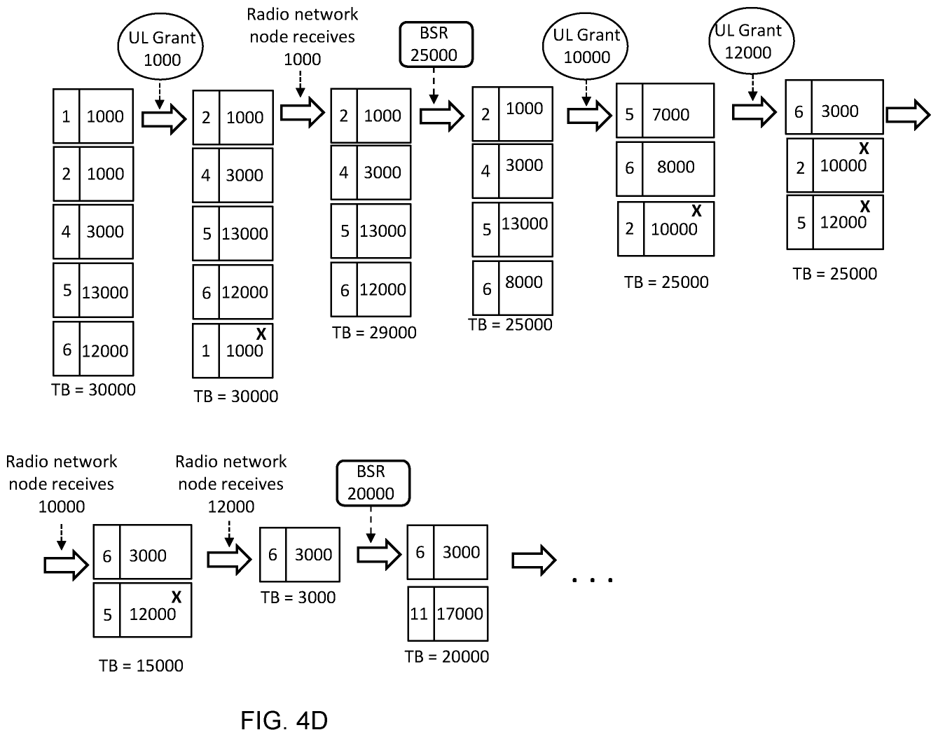

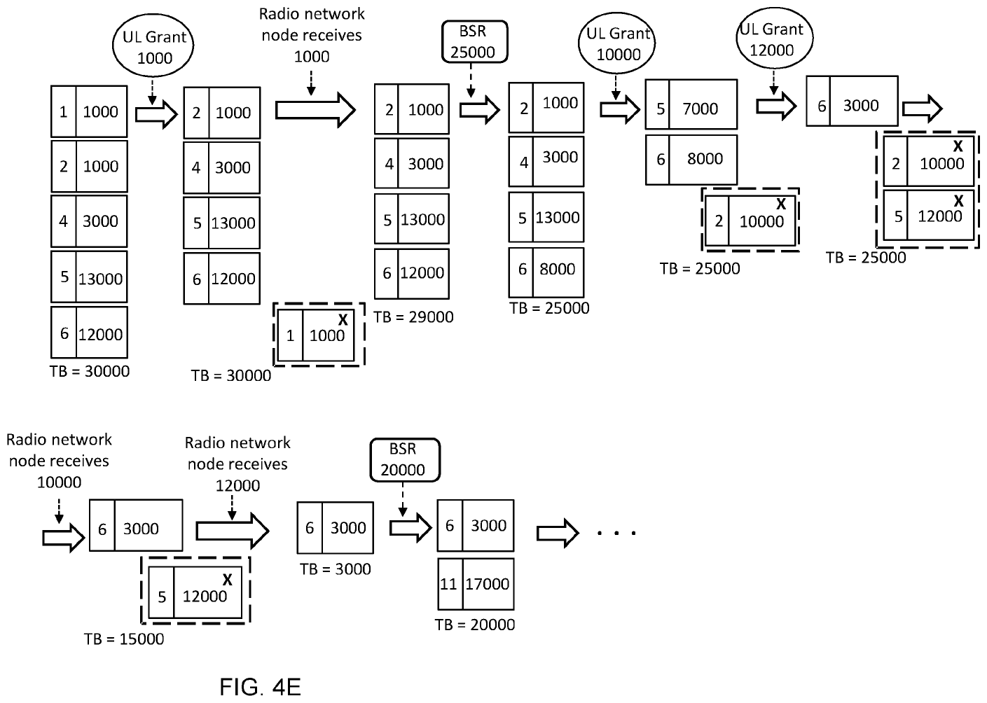

The radio network node determines a difference between the current amount of data indicated in the BSR message and the sum of data values stored in the age map, for a logical channel or a logical channel group, of the radio network node. The sum of the data values stored in the age map is a sum of data values in all current entries in the age map. For example, as shown by way of example in FIG. 4A, discussed in more detail below, a total number of bytes (“TB”) in an age map may be 1000, see column 1 in FIG. 4A showing an example of the age map at a certain timepoint.

The difference between the current amount of data indicated in the BSR message and the sum of data values stored in the age map may be a positive value, a negative value, or a zero i.e. no difference. For example, as shown in FIG. 4A, column 1, the total number of bytes (“TB”) in the age map may be 1000, whereas the BSR message may also indicate a data value of 1000 bytes. The difference between the current amount of data indicated in the BSR message, 1000, and the sum of data values stored in the age map, 1000, is thus zero. In this case, no new entry is created in the age map since the BSR message indicates that no new data has been stored in the UL buffer of the UE 10 since the receipt of a prior, most recent BSR message by the radio network node 12.

If the difference between the current amount of data, as indicated in the BSR message, and the sum of data values stored in the age map is a positive or negative value, the radio network node 12 updates the age map as discussed below.

Action 306. With the proviso that the difference is a positive value, the radio network node 12 adds a new entry to the age map, the new entry having a timestamp corresponding to a time of receipt of the BSR message and a data value corresponding to the difference.

In some examples, the timestamp corresponding to a time of receipt of the BSR message comprises an estimated arrival time to the UL buffer of the UE 10 of data corresponding to the difference.

In some examples, the timestamp corresponding to a time of receipt of the BSR message comprises any one of:
a current time, i.e., the time of receipt of the BSR message by the radio network node 12;
the current time minus an offset accounting for a time from an arrival to the UL buffer of the UE 10 of data corresponding to the new entry until the time of receipt of the BSR message; and
a due time for the UE 10 to transmit the data corresponding to the new entry to the age map.

The due time may be defined as a latest time by which the UE 10 should have transmitted the data to meet the packets' QoS requirements.

Action 308. With the proviso that the difference is a negative value, the radio network node 12 may remove or update at least one entry in the age map such that the sum of data values stored in the age map is decreased in accordance with the difference, i.e. in accordance with a magnitude of the difference. Although the difference will typically be a positive value, as in Action 306 which indicates that the radio network node 12 has received a report of new data in the UE's UL buffer, the difference may alternatively be negative in some cases. This may occur because of a finer granularity of the BSR message for smaller buffer sizes. For example, in the BSR message, the UE may not signal the actual number of buffered bytes but an index value that refers to a defined range of bytes. For example, an index value may be defined such that the UE has a range of between 536 and 745 bytes in its buffer. Another index value may be associated with a range of between 746 and 1038 bytes. A UE having 750 bytes of data in its buffer would hence signal the index value associated with the latter range. The radio network node intends to serve all the data that may be queued in the UE, and it may interpret that BSR index value as if the UE has the number of bytes associated with the upper edge of the buffer size range (e.g. 1038 bytes). If the radio network node subsequently indicated to the UE that it may send 100 bytes, it assumes that the UE has 938 remaining byte in its buffer. However, when the UE sends the allowed 100s byte, its queue shrinks from 750 bytes to 650 bytes. Hence, in a subsequent BSR, the UE will indicate the next index value associated with the next lower range (536 to 745 bytes) of which the radio network node assumes the upper edge (745 bytes). In this case, the difference between the value derived from the new BSR (745 bytes) and the sum of the data in the age map (938 bytes) is negative.

In some cases, the difference is a negative value because of a coarse granularity of the BSR message such that prior BSR message(s) caused the radio network node 12 to account for more data than was actually in the UL buffer of the UE.

In some examples, the radio network node 12 may remove or update the at least one entry in the age map that comprises an entry with a newest timestamp.

In some cases, the difference is a negative value because of dropped packets at the UE, which are typically the oldest packets. Thus, the UL buffer of the UE may include less data than the radio network node 12 expects it to have based on information in the age map.

In some examples, the radio network node 12 may remove or update the at least one entry in the age map that comprises an entry with an oldest timestamp, which may be referred to as an oldest entry corresponding to at least one oldest packet. The oldest packets are typically more likely to be sent from the UL buffer of the UE.

Action 310. As discussed above, in some embodiments, the BSR message may be extended to further indicate a time from an entry time when data indicated by the current amount of data in the BSR message entered the UL buffer of the UE until a transmission time when the BSR message is transmitted by the UE. For example, the BSR message may comprise an additional field indicating the time, or age, that comprises an age of an oldest packet in the UL buffer of the UE.

In such embodiments, the radio network node 12 may update a timestamp of an oldest entry in the age map by replacing the timestamp of the oldest entry with the age of the oldest packet in the UL buffer, wherein the age of the oldest packet in the UL buffer is received in the BSR message. This allows re-synchronizing the age/data pairs in the age map (which is an estimate) with the actual status in the UE. Such mismatch may occur if the UE dropped data from its queue in the UL buffer and if the radio network node does not know whether the UE dropped from the front or tail of the queue. This allows managing the age map in a manner that accounts for dropped packets at the UE 10. Without such time stamps, a re-synchronization may be ensured every time the radio network node 12 obtains a BSR indicating that the UE's queue is empty.

Action 312. The radio network node 12 uses the age map to determine resources for data transmission from the UL buffer of the UE 10 to the radio network node 12, and indicates the determined resources to the UE 10. The resources may be indicated in a UL grant, and the UL grant may indicate an amount of data that may be transmitted from the UL buffer of the UE to the radio network node 12.

The determined resources may comprise, e.g., transmission frequencies, transmission codes, time slots, and/or other resources, etc. The UL grant may also comprise an indication of the modulation scheme which is to be used for transmitting the data.

The radio network node may assign the determined resources, such as radio resources, to the UE, in a unit of slots, e.g., one or more slots. The radio network node may determine, for each time interval, or slot, which UE(s) are going to transmit UL data and may configure transmission parameters.

The radio network node 12, e.g., a gNB, may store and adjust respective age maps for multiple UEs, in accordance with embodiments of the present disclosure. In making grant allocation decisions, the radio network node 12 may consider an age of the oldest packet among more than one UE. Thus, in some cases, resources may first be allocated for the UE storing the oldest data in its UL buffer.

The use of the age map provides various advantages. For example, if data packets are required to be transmitted within, e.g., at most 50 ms (delay budget=50 ms), the radio network node may use the age map to determine the latest time by which it should allocate UL radio resources for the oldest pending packet. When allocating those radio resources, the radio network node may in addition allocate resources for subsequent newer data portions even if their age is not yet equally close to the delay budget. By allocating additional resources and enabling the UE to send also the less urgent packets the network can save scarce control signaling resources (i.e. the resources in which the radio network node informs the UE about the resources it may use for the UL transmission). Furthermore, the age map allows the radio network node such as a gNB to also keep track of the age of the remaining portions of data which it could not yet schedule. Particularly, when the radio network node uses age maps to supervise the UL data buffers of several UEs, it may thereby ensure a timely transmission of all pending UL data and maximize the system capacity, i.e., the total throughput and the number of UEs that can be served. Furthermore, the radio network node may use an age, or a time in the UL buffer (queue) for the data reported by the BSR, to determine how robust a first transmission attempt should be. Thus, if the age (for a portion of the data in the queue) is almost as high as the allowable delay budget, the radio network node may choose a lower code rate (fewer information bits per coded bit) and thereby make the transmission less likely to fail and less likely to require one or more time-consuming retransmissions.

Action 313. The radio network node 12 may indicate the determined resources, which are determined using the age map, as a grant to the UE 10 comprising an indication of resources for a certain amount of data in the UL buffer of the UE for transmission to the radio network node 12. The grant may be a UL grant comprising the indication of allocated resources and the amount of data, e.g., in bytes, for transmission using the allocated resources.

The resources may be determined as part of using the age map to determine resources for data transmission from the UL buffer to the radio network node and indicating the determined resources to the UE, as discussed above in connection with Action 312.

Action 315. The radio network node 12 receives the certain amount of data from the UE in accordance with the grant, such as a UL grant. The certain amount of data is transmitted by the UE using the resources allocated for the transmission according to the UL grant.

The certain amount of data may be received, e.g, in a MAC PDU or in another data unit. The certain amount of data may be received together with a BSR.

Action 317. When the radio network node 12 receives the certain amount of data from the UE 10, as indicated in Action 315, the radio network node 12 may remove or update at least one entry in the age map such that the sum of data values stored in the age map is decreased in accordance with the certain amount of data received from the UE. In this case, the at least one entry in the age map may comprise an entry with an oldest timestamp. Thus, for example, if the radio network node 12 grants a UL grant to the UE 10 comprising 4000 bytes, if the oldest entry in the age map has a value of 4000 bytes, the entire entry is removed from the age map. If, as another example, the oldest entry in the age map has a value of 3000 bytes, that entry is removed and a next oldest entry is either removed (if it has a value of 1000 bytes) or updated such that its value is decreased by 1000 bytes. In this way, the radio network node 12 keeps track of what it expects to be stored in the UL buffer of the UE 10.

In some cases, when the radio network node sends a UL grant to the UE and the UE then sends data to the radio network node in accordance with that UL grant, a BSR reflecting the fact that the size of the UL buffer of the UE is decreased is sent together with the data to the radio network node.

When a UE sends a BSR, it may send the BSR in a transport block that may also include the UL data. A value indicated in the BSR, such as an index value, reflects the new buffer size, i.e., the size that takes into account the amount of data that the UE has just sent. However, by the time a radio network node, e.g., a gNB, receives this BSR, the value indicated in the BSR may be older than one slot old, or more than one slot old. For example, since the UE needs some time to package and encode the transport block and the gNB needs time to decode and unpack it, it may take, e.g., 2-3 slots. And, similarly, the gNB needs some time to package and encode a UL grant that it decided to send. The transmission of the UL grant takes some time, and then the UE needs time to decode it and to decide which data to send. Thus, in some cases, it may take, e.g., about 5-8 time slots from the time when the gNB decides to schedule the UE until the slot where it can take the effect of that scheduling decision into account for a subsequent scheduling decision. In between those two scheduling decisions, the gNB may have to make intermediate scheduling decisions. For example, such decisions may depend on a duplex mode. For example, in a Frequency Division Duplex (FDD) cell, each slot may be used for UL and DL transmissions. Hence, there may be, e.g., up to 5-8 UL processes “in flight” at any point in time. As another example, in a Time Division Duplex (TDD) system, only some slots are used for UL transmissions.

The radio network node 12 operating in accordance with embodiments herein may adjust the age map and may perform UL grant scheduling while taking into consideration that it may take a certain number of slots from the time when the radio network node 12 decides to schedule the UE until the slot where the radio network node 12 can take the effect of that scheduling decision into account for a subsequent scheduling decision.

In some cases, when the radio network node sends an UL grant to the UE, it may take several slots before the UE sends the corresponding BSR and the data for which resources were granted, e.g., in a MAC PDU, and before the radio network node decodes the MAC PDU. Accordingly, if the radio network node would reduce the size of the age map at a time when it sends the grant, it may subsequently decode other UL PDUs from the same UE, which the radio network node scheduled earlier. And if those PDUs include BSRs, the amount of data indicated by these BSRs will not yet reflect the reduced UL buffer size due to the most recent UL grant. In other words, intermediately arriving BSRs may not consider the UL grants that are still “in flight”. The intermediate BSRs would thus seem to report more data than what the radio network node expected, and the radio network node may erroneously add a new entry to its age map. This may be avoided if the radio network node reduces the size of the age map only upon arrival of the UL data and not when sending the grant. However, if the radio network work makes another scheduling decision in the next slot, the age map would still show data for which an UL grant is already sent or “in flight.” The radio network node may thus send a subsequent grant which the UE may not be able to use anymore, i.e. due to padding. Thus, more UL grants may be sent to the UE than the UE needs to drain its UL buffer/queue.

The present disclosure addresses these potential complications, and additionally allows avoiding a situation when the radio network node issues grants for the most urgent data for which the radio network node has however already sent a grant that is still in flight, i.e. it has been sent to the UE but the UE has not yet sent the data in accordance with the grant.

Accordingly, the radio network node may, upon sending a UL grant, reduce the size of the oldest age map entry but add another age map entry with the same size and timestamp and mark that added entry as corresponding to the UL grant that is “in-flight”. In the next scheduling occasion, i.e., the next slot, the radio network node then disregards the entries marked as in-flight and thereby avoids over-allocating resources. When new BSRs arrive, the radio network node does take the in-flight entries into account when computing the expected amount of data in the UL buffer/queue. This avoids a situation that an intermediate BSR re-adds data to the age map for which a grant is actually already in flight. When receiving data from the UE, the radio network node then deducts and removes the entries previously marked as in-flight.

In aspects of the present disclosure, the age map is maintained in a manner such that a possibility of the radio network node scheduling and sending more than one grant for the same entry in the age map is avoided.

In some embodiments, as mentioned above and discussed in more detail in connection with FIG. 3B, one or more entries in the age map, or in a supplementary age map, at the radio network node may have been marked or flagged when the UL grant had been sent to the UE indicating resources for the certain amount of data. These flagged entries remain in the age map until the radio network node 12 actually receives the certain amount of data for which it had granted the resources. It may take time for the UE to reply to a given UL grant, and, in the meantime, the radio network node may schedule and send subsequent UL grants. When doing so, the radio network node should not send more grants for the same portion of data, i.e., for the same age map entries that it scheduled before. Thus, any intermediary resource allocation, i.e., subsequent UL grants (after the UL grant for the certain amount of data and before the receipt of this data), will occur at the radio network node without taking into consideration the flagged entries.

FIG. 3B illustrates in more detail a process of updating an age map in the radio network node 12. FIG. 3B supplements the process shown in FIG. 3A. The process shown in FIG. 3B comprises the following actions, which actions may be taken in any suitable order. Optional actions are referred to as dashed boxes in FIG. 3B.

Action 313. As in FIG. 3A, the radio network node 12 may indicate determined resources, which are determined using the age map, as a grant to the UE 10 comprising resources for a certain amount of data in the UL buffer of the UE for transmission to the radio network node 12. The grant may be a UL grant.

Action 314. In some embodiments, when the radio network node issues a grant to the UE, the radio network node may remove one or more entries in the age map that are worth the size of the grant. The radio network node also adds, e.g, immediately, a new age map entry, or an entry into a separate bucket, with the same amount of data but with an indicator, such as e.g. a flag, indicating that a grant for this amount of data is already in-flight, i.e. had been set to the UE. The radio network node thus indicates to itself which entries in the age map, or in a related storage, are set aside for the already issued UL grant. The radio network node then considers those age map entries when receiving new BSRs from the UE, to avoid adding new age map entries in error, but the radio network node does not consider these flagged entries when deciding whether to issue new grants.

Accordingly, after indicating the determined resources as the grant to the UE comprising resources for the certain amount of data in the UL buffer of the UE for transmission to the radio network node, and before receiving the certain amount of UL data from the UE, the radio network node may remove or update at least one entry in the age map such that the sum of data values stored in the age map is decreased in accordance with the certain amount of data in the grant. The at least one entry in the age map may comprise an entry with an oldest timestamp.

As the radio network node removes or updates the at least one entry in the age map to account for the UL grant it has sent to the UE, the radio network node may add at least one flagged entry to the age map with the oldest the timestamp and indicate the certain amount of data for which the resources are included in the grant and, the at least one flagged entry being associated with an indicator indicating that a grant for the certain amount of data indicated in the at least one flagged entry in the age map has already been given to the UE.

The at least one flagged entry may be an entry in the age map that is marked in any suitable way to indicate that resources for an amount of data indicated in this entry have been already allocated in a UL grant to the UE. The flagged entries may in some cases be flagged in the sense that they are added into a separate portion of the age map, such as in a separate bucket of entries. As another example, the flagged entries, which may or may not be associated with an indicator such as e.g. a flag, may be added into a location separate from the age map such as e.g. a supplementary age map storing only entries that correspond to data for which resources have been assigned to the UE.

Action 315. As in FIG. 3A, the radio network node 12 receives the certain amount of data from the UE in accordance with the UL grant previously sent to the UE. The certain amount of data may be received, e.g, in a MAC PDU or in another data unit. The certain amount of data may be received together with a BSR.

Action 317. The radio network node may remove or update at least one entry in the age map such that the sum of data values stored in the age map is decreased in accordance with the certain amount of data received from the UE. Thus, once the radio network node 12 receives the certain amount of data from the UE in accordance with the UL grant previously sent to the UE, the radio network node removes or updates at least one entry in the age map that is a flagged entry that indicates an amount of data for which resources have already been assigned to the UE. For example, with reference to FIG. 4D discussed in more detail below, a flagged entry, indicating 10000 bytes that was created once a UL grant for 10000 bytes was sent, is removed from the age map once the radio network node receives the corresponding 10000 bytes from the UE.

Action 319. The radio network may indicate the determined resources to the UE as a subsequent grant to the UE comprising resources for a certain second amount of data in the UL buffer of the UE for transmission to the radio network node. The indication may be performed as part of using the age map to determine resources for data transmission from the UL buffer to the radio network node and indicating the determined resources to the UE, as discussed above in connection with Action 312 of FIG. 3A. In this case, using the age map to determine the resources as the subsequent grant to the UE comprises taking into consideration one or more entries in the age map other than the at least one flagged entry.

The UL grant, as indicated in Action 313, may have been sent to the UE a certain time ago, such that one or more BSRs, and/or one or more subsequent grants may be received after the receipt of the UL grant. The radio network node allocates resources for the subsequent UL grant(s) without taking into consideration entries in the age map that were flagged as corresponding to already allocated one or more prior UL grants. The flagged entries remain in the age map or in association with the age map until the radio network mode receives the UL data from the UL in accordance with corresponding UL grants. For example, with reference to FIG. 4D, after the UL grant for 10000 bytes is sent to the UE and a respective flagged entry is added to the age map, another UL grant for 12000 bytes may be sent and a respective flagged entry is added to the age map while taking into consideration only the entries in the age map other than the entry corresponding to the prior UL grant for 10000 bytes.

FIGS. 4A-4E show examples of maintaining and updating an age map in a method performed by a radio network node, such as a radio network node 12, according to embodiments herein. FIG. 4A shows columns, numbered from 1 to 13, each representing a state of the age map at a certain time point, for illustration purposes only. The age map includes, at any point in time, one or more entries, each entry comprising a data value and an associated timestamp or age, the data value indicating a number of bytes associated with that timestamp. Table 1, below, additionally shows a sequence of entries in the age map of FIG. 4A, based on BSR messages and data received from the UE i.e. an amount of data for transmission of which resources were previously granted by the radio network node 12. Table 1 supplements FIG. 4A, though it includes additional entries not shown in FIG. 4A.

In FIG. 4A, BSR messages, also interchangeably referred to as BSRs, are each represented by an indication, e.g., an index value, of an amount of data, also referred to herein as a current amount of data, in bytes, in a UL buffer of a UE, such as, e.g., the UE 10. The radio network node 12 may similarly receive a BSR from the UE 10′ or another UE, regarding data in a UL buffer of that UE. FIG. 4A also shows, as a number of bytes, data received by the radio network node from the UE 10.

As discussed above, the radio network node 12 may update the age map as it receives data from the UE 10 in accordance with a UL grant previously sent by the radio network node to the UE. The updating of the age map may involve taking into consideration UL grants, before the data is actually received from the UE 10 in accordance with those grants, which is discussed in more detail below, in connection with FIGS. 4B-4E. FIG. 4A illustrates generally a process of maintaining and updating the age map at the radio network node 12.

Referring back to FIG. 4A, at a first time point (time=1), a BSR indicating 1000 bytes results in entry 1 in the age map, with a timestamp 1 and an associated amount 1000 bytes, such that the total number of bytes in the age map (“TB”) is 1000. After a second BSR indicating 2000 bytes, at time=2, a second entry is added to the age map, with a timestamp 2 and an associated amount 1000. For illustration purposes only, the new entry is added to the bottom of, or below, the first entry. The second entry is added because the current amount of data in the BSR message, 2000 bytes, is greater than a sum of data values stored in an age map, which is 1000 bytes. The total number of bytes in the age map thus becomes 2000 bytes.

A third BSR again, like the second BSR, indicates 2000 bytes, and the current amount of data in the BSR message is thus the same as the sum of data values stored in an age map. In other words, a difference between the current amount of data indicated in the second BSR and a sum of data values stored in the age map is zero. No new entry is added to the age map at this point. Thus, there is no entry in the age map with a timestamp 3.

Further, as BSR messages indicating 5000, 18000, and 30000 bytes are received by the radio network node 12, respective new entries are added to the age map since a difference between the current amount of data indicated in a respective BSR message and a sum of data values stored in the age map at a time the BSR message is received is a positive value. The age map looks like as shown in the 6th column, or the 6th time point, in FIG. 4A.

At that point, the radio network node receives 1000 bytes from the UE. As a result of the data receipt from the UE, the oldest entry with a timestamp 1 is removed from the age map, as shown in the 7th column in FIG. 4A. This time entry happens to have an indication of the amount of 1000 bytes, and the entire entry is thus removed to account for the receipt of the UE data. The total number of bytes in the age map becomes 29000 bytes. Because the UE 10 would typically send its oldest data first, the age map may be updated, in response to the receipt of the UE data, in accordance with a respective UL grant, to remove or adjust one or more of the oldest entries therein.

Next, a 7^{th} BSR indicating 25000 bytes is received, such that the current amount of data in the BSR message is smaller than the sum of data values stored in the age map, which is 29000. In other words, the difference between the current amount of data indicated by the BSR message, and the sum of all data values stored in the age map is a negative value. In aspects in accordance with the present disclosure, when the amount of data reported in the BSR is smaller than the total number of bytes in the age map that the radio network node expects, e.g., due to finer granularity for smaller buffer sizes, one or more newest or youngest, i.e. most recently added, entries are removed or updated. Accordingly, because there is a 4000 bytes-difference between the 25000 bytes indicated in the BSR and the sum of data values stored in the age map, 29000, 4000 bytes are removed from the latest, or youngest, entry in the age map, such that that entry, with a timestamp 6, becomes associated with an amount of 8000 rather than 12000 bytes, as shown in the 8^{th} column representing a current state of the age map.

A subsequent receipt of UL UE data of 10000 bytes results in removal of an entry with a timestamp 2 indicating 1000 bytes and an entry with a timestamp 4 indicating 3000 bytes. The remaining 6000 bytes received from the UE are accounted for by updating the entry with a timestamp 5, as shown for the 8th and 9th columns in FIG. 4A. A further receipt of UL UE data of 12000 bytes results in removal or updating of at least one entry in the age map such that the sum of data values stored in the age map is decreased in accordance with the amount of the received UL UE data, which is 12000 bytes. Accordingly, in this case, once the radio network node receives 12000 bytes from the UE, an entry with a timestamp 5 indicating 7000 bytes is removed from the age map and an entry with a timestamp 6 is updated to thereby indicate, after the update, 3000 bytes. As a result, the age map includes the single entry with a timestamp 6 indicating 3000 bytes, as shown in 10^{th} column.

As shown in 11^{th} column in FIG. 4A, a receipt of a BSR indicating 20000 bytes leads to an addition of a new entry with a timestamp 11 and the associated amount, or data value, of 17000 bytes, which is a value of the difference between the current amount of data in the BSR and a sum of data values stored in an age map, 3000. A subsequent receipt of UL UE data of 2000 bytes results in an update of the oldest entry in the age map, such that this entry, with a timestamp 6, indicates 1000 bytes instead of previously indicated 3000. Another receipt of 2000 bytes of UL UE data by the radio network node results in removal of the oldest entry with the timestamp 6 and an update of the next oldest entry with a timestamp 11. The process of updating the age map may continue in a similar manner as the radio network node 12 communicates with the UE 10.

Table 1 shows: a timepoint (t); a number of bytes in a BSR; a number of bytes received from the UE, i.e. UL data; a number of entries in the age map at a timepoint; a total number of bytes in the age map at a timepoint when a BSR is received or the radio network node receives UL UE data; and an oldest age map entry represented by a timestamp and a number of bytes, also referred to herein as a data value, associated with the corresponding timestamp. It should be appreciated that specific values are shown in FIG. 4A and in Table 1 for illustration purposes only, and that an age map in accordance with the present disclosure may include any values of any suitable format.

TABLE 1

| | | | Entries in | Total | Oldest Age Map Entry | |
|---|---|---|---|---|---|---|
| t | BSR | UL data | map | Bytes | Timestamp | Bytes |
| 1 | 1000 | | 1 | 1000 | 1 | 1000 |
| 2 | 2000 | | 2 | 2000 | 1 | 1000 |
| 3 | 2000 | | 2 | 2000 | 1 | 1000 |
| 4 | 5000 | | 3 | 5000 | 1 | 1000 |
| 5 | 18000 | | 4 | 18000 | 1 | 1000 |
| 6 | 30000 | | 5 | 30000 | 1 | 1000 |
| 7 | | 1000 | 4 | 29000 | 2 | 1000 |
| 8 | 25000 | | 4 | 25000 | 2 | 1000 |
| 9 | | 10000 | 2 | 15000 | 5 | 7000 |
| 10 | | 12000 | 1 | 3000 | 6 | 3000 |
| 11 | 20000 | | 2 | 20000 | 6 | 3000 |
| 12 | | 2000 | 2 | 18000 | 6 | 1000 |
| 13 | | 2000 | 1 | 16000 | 11 | 16000 |
| 14 | | 2000 | 1 | 14000 | 11 | 14000 |
| 15 | 12000 | | 1 | 12000 | 11 | 12000 |
| 16 | | 3000 | 1 | 9000 | 11 | 9000 |
| 17 | | 3000 | 1 | 6000 | 11 | 6000 |
| 18 | 5500 | | 1 | 5500 | 11 | 5500 |
| 19 | | 2000 | 1 | 3500 | 11 | 3500 |
| 20 | | 1000 | 1 | 2500 | 11 | 2500 |
| 21 | | 1000 | 1 | 1500 | 11 | 1500 |
| 22 | | 1000 | 1 | 500 | 11 | 500 |
| 23 | 500 | | 1 | 500 | 11 | 500 |
| 24 | | 600 | 0 | 0 | | |

FIGS. 4B-4E illustrate in further detail examples of how the age map at the radio network node, such as the radio network node 12, is updated as the radio network node 12 communicates with the UE such as the UE 10. More specifically, FIGS. 4B-4E illustrate updating the age map

The examples in FIGS. 4B-4E are based on the example in FIG. 4A, although there may be difference in some entries of the age map and/or in the order in which the entries in the age map are updated, added, or removed.

An example of FIG. 4B begins with the timepoint 6 in FIG. 4A, where the total amount of data in the age map is 30000 bytes. At that point, a UL grant of 1000 bytes may occur, meaning that the radio network node grants resources for UL transmission of 1000 bytes from the UE UL buffer. As the radio network node grants the UL grant of 1000 bytes to the UE, the radio network node flags or marks the oldest entry in the age map, with is the entry indicating 1000 bytes. As shown in FIG. 4B, that oldest entry becomes associated with an indicator, shown by way of example only as “X”. It should be appreciated however that the entry may be flagged or marked with an indicator in any suitable manner to indicate that the grant for the amount of data indicated in that flagged entry in the age map has already been given to the UE. In other words, the indicator indicates that this entry is not to be used to subsequent UL grant allocations.

Once the radio network node receives the data from the UE for which the grant of 1000 bytes has been issued, the flagged entry is removed from the age map to account for the actual receipt of the data in accordance with the grant, as shown in FIG. 4B. In this way, the age map accounts for the flagged entry until the data in accordance with the UL grant is received at the radio network node.

As shown further in FIG. 4B, a BSR indicating 25000 bytes may further be received and the age map is updated accordingly. Similarly to the example in FIG. 4A, the entry with a timestamp 6 becomes associated with an amount of 8000 bytes rather than 12000 bytes.

Next, a UL grant of 10000 bytes is sent and three oldest entries in the age map are flagged accordingly, to account for 10000 bytes for which the UL grant has been given to the UE. The entry with the timestamp 5 is marked to indicate that 6000 bytes out of its 13000 bytes is now part of the data associated with the UL grant. Once the radio network node receives the data from the UE for which the grant of 10000 bytes has been issued, the flagged entries are removed or, like the entry with the timestamp 5, are updated to account for the actual receipt of the data in accordance with the UL grant.

When an age map includes one or more flagged entries, which correspond to UL grants, and one or more entries that are not flagged, the radio network node may prioritize for removal the flagged entries once UL data arrives from the UE at the radio network node. Among the flagged entries, the radio network node may prioritize for removal those with the earliest timestamp(s). Also, in some cases, the radio network node may set or change a value of a timestamp in a flagged entry, to make the value correspond to an earlier time point. In this way, the radio network node would treat that flagged entry as an “older” entry than other entries, which may be flagged or not flagged, and the radio network node may prioritize for removal this older flagged entry once the radio network node receives data from the UE.

It should be noted that FIG. 4B illustrates that the radio network node receives data from the UE immediately after it sends the respective UL grant with certain simplification. As discussed above, before the radio network node receives data in accordance with a UL grant sent by the radio network node, one or more BSRs may be received by the radio network node, and/or one or more subsequent UL grants may be sent by the radio network node.

Accordingly, FIG. 4B also illustrates that, when a UL grant for 12000 bytes is sent by the radio network node and entries in the age map are flagged accordingly, a subsequent BSR indicating 20000 may be received. When it receives this BSR, the radio network node considers all entries in the age map, including the flagged age map entries which accumulate to 15000 in this example. Hence a new entry indicating 5000 is added to the age map. The radio network node does not consider the flagged entries when deciding whether to issue new grants. Thus, for example, if a new grant were to be sent, after the BSR indicating 20000 byte has been received, the radio network node would consider the remaining 3000 bytes with the timestamp 6 in this example, which is not flagged, and the size of the new entry indicating 5000 byte. When the radio network node then receives the 12000 bytes from the UE for which the UL grant has been previously issued, the flagged entries are removed or, like the entry with the timestamp 6, are updated to account for the actual receipt of the data in accordance with the UL grant. As mentioned above, before the issue of the UL grant of 12000 bytes (or any other UL grant), and the receipt of the respective UL UE data, one or more further UL grants may be sent by the radio network node, resources of which are allocated by considering entries in the age map other than one or more flagged entries.

FIGS. 4C and 4D illustrate further examples, also based on the example of FIG. 4A, where, upon the radio network node sending a UL grant to the UE, respective one or more entries in the age map are removed or updated, and then new flagged entries are added to the age map. Thus, as shown for the first UL grant of 1000 bytes in FIG. 4C, the oldest entry of 1000 bytes is removed and a corresponding new flagged entry indicating 1000 bytes is added to the age map. Similarly, as the UL grants of 10000 and 12000 bytes are sent, respective entries in the age map are removed or updated, and then new flagged entries are added to the age map. The new flagged entries replicate the respective entries just removed from the age map, with the same indicated amount of data (e.g., the entries with timestamps 2 and 4) or with the updated indicated amount of data, e.g., the entry with the timestamp 5. The flagged, or otherwise indicated, e.g., by being stored in a separate portion of the age map or in a different, supplementary age map, entries are removed when the respective data arrives from the UE.

As shown in FIG. 4D, after the UL grant for 10000 bytes is sent by the radio network node and respective entries are flagged, for allocation of the subsequent grant for 12000 bytes, the radio network considers only entries in the age map other than flagged, i.e. not flagged entries. Thus, in this example, the radio network node considers the entries with the timestamps 5 and 6, which are not flagged, for allocation of the subsequent grant for 12000 bytes. In this way, a possibility of the radio network node sending multiple grants for the same entry in the age map is avoided.

In aspects of the present disclosure, after indicating the determined resources as the grant to the UE comprising resources for the certain amount of data in the UL buffer of the UE for transmission to the radio network node, and before receiving the certain amount of UL data from the UE (using the grant), the radio network node may remove or update at least one entry in the age map such that the sum of data values stored in the age map is decreased in accordance with the certain amount of data in the grant. The at least one entry in the age map comprises an entry with an oldest timestamp, or, if more than one entry is removed or updated, one or more entries with next oldest timestamps.

Such removal and/or update of one or more entries in the age map may be followed by addition of at least one flagged entry to the age map, with the oldest (and possibly also next oldest) timestamp and indicating the certain amount of data for which the resources are indicated in the grant. The at least one flagged entry may be associated with an indicator indicating that a grant for the certain amount of data indicated in the at least one flagged entry has already been given to the UE.

As shown in FIG. 4D, a new flagged entry may be added for the entire amount of data indicated in the UL grant. Thus, FIG. 4D shows that, in response to the UL grant of 1000 bytes, the entries with timestamps 2 and 4 are removed from the age map, the entry with the timestamp 5 is updated, and a new flagged entry indicating 10000 bytes is added.

In this way, as in the examples of FIGS. 4B and 4C, the amount of data for which the radio network node sends a grant is still visible in the age map. Because the UE has in fact not yet sent the data, the reduction of the UL buffer size is not yet reflected in BSRs that arrive before the data for which the grant has been sent.

The new flagged entry has a timestamp, 2 in this example, corresponding to the oldest timestamp among the entries removed from the age map to account for the UL grant of 1000 bytes. Similarly, to account for the UL grant for 12000 bytes, the entry with the timestamp 5 indicating 7000 bytes is removed, the entry with the timestamp 6 is updated, and a new flagged entry of 12000 bytes is added. The respective flagged entries are removed from the age map upon receipt of UL data.

An example of FIG. 4E is similar to the example of FIG. 4D, and additionally illustrates that entries, each indicating a certain amount of data for which a UL grant has been sent to the UE, may be stored in a separate data structure, such as, e.g., a supplementary age map. FIG. 4E schematically shows such entries delineated with a dashed line. The entries may also be added into a separate portion of the age map, and they may be flagged using a suitable indicator or they may not include a flag. Regardless of their specific location and the way in which they are marked, the entries are maintained in the age map or in association with the age map so that they contribute to the total amount of data indicated in the age map, and at the same time they are not used for resource allocation scheduled in connection with subsequent UL grants.

In aspects of the present disclosure, as mentioned above, a BSR message is extended to include additional information. The BSR may be extended with information on when the data entered a UL buffer of the UE, i.e. the age of the oldest packet in the UL buffer indicating how long time ago relative to the BSR the data entered the UL buffer.

Thus, the BSR may explicitly indicate how long time ago relative to a time of transmittal of the current BSR the data entered the UL buffer of the UE. This additional information may be derived from a packet arrival on chip set/modem level, provided by an application, or otherwise obtained by the UE. In some embodiments, the BSR is extended by a field. The field may indicate the age of the oldest packet in the UE's UL buffer, not considering packets that are transmitted alongside with the BSR at this transmission instance. The age of the oldest packet may be indicated per logical channel or logical channel group, i.e., for the oldest packet in a UL buffer for the respective logical channel or logical channel group.

In some embodiments, the age of the oldest packet in the UL buffer of the UE can be indicated as system frame number (SFN), of a time at which the oldest packet arrived in the UL buffer of the UE. Quantization can be applied when including this information in the BSR, e.g., only the X least significant bits of the SFN may be indicated, and the radio network node, such as a gNB, determines the full SFN itself.

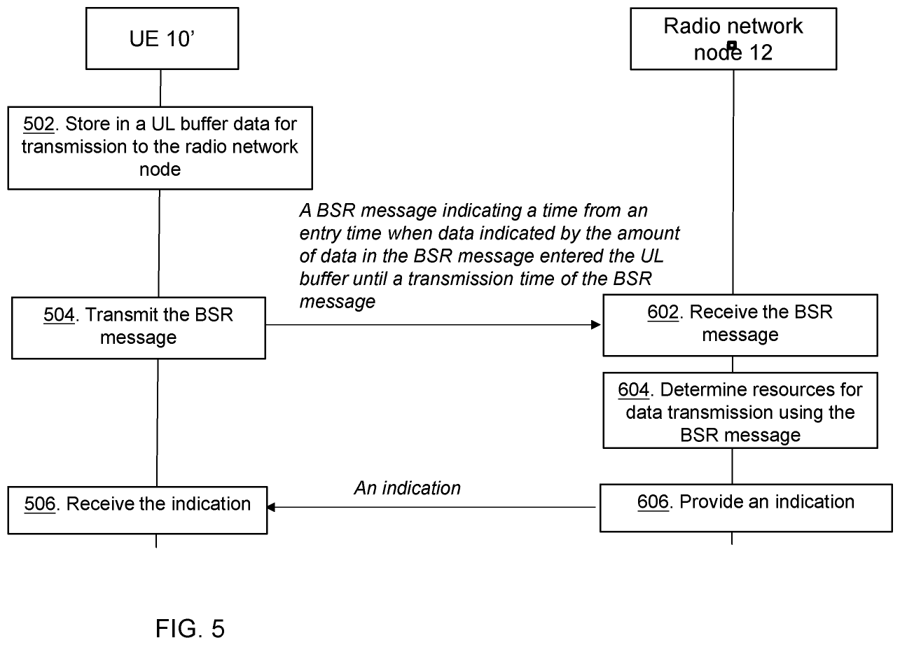

FIG. 5 is a combined signalling scheme and flowchart depicting embodiments herein related to a UE, such as the UE 10′, sending an extended BSR to a radio network node, such as the radio network node 12. The UE 10′ may be similar or the same as the UE 10, and it is shown and described separately herein only to illustrate an example of the aspect of the present disclosure related to an extended BSR.

The process shown in FIG. 5 comprises the following actions, which may be taken in any suitable order.

Action 502. The UE 10′ stores, in a UL buffer of the UE 10′ data for transmission to the radio network node.

Action 504. The UE 10′ transmits a BSR message to the radio network node 12, the BSR message indicating an amount of data in the UL buffer and a time from an entry time when data indicated by the amount of data in the BSR message entered the UL buffer of the UE until a transmission time when the BSR message is transmitted by the UE.

Action 602. The radio network node 12 receives the BSR message from the UE 10′.

Action 604. The radio network node 12 determines resources for data transmission from the UL buffer of the UE to the radio network node, wherein the resources are determined using information in the BSR message.

Action 606. The radio network node 12 provides to the UE an indication of the determined resources. The indication may be an UL grant.

Action 506. The UE 10′ receives, from the radio network node 12, an indication of resources determined for data transmission from the UL buffer to the radio network node, wherein the resources are determined using information in the BSR message. The indication may be a UL grant.

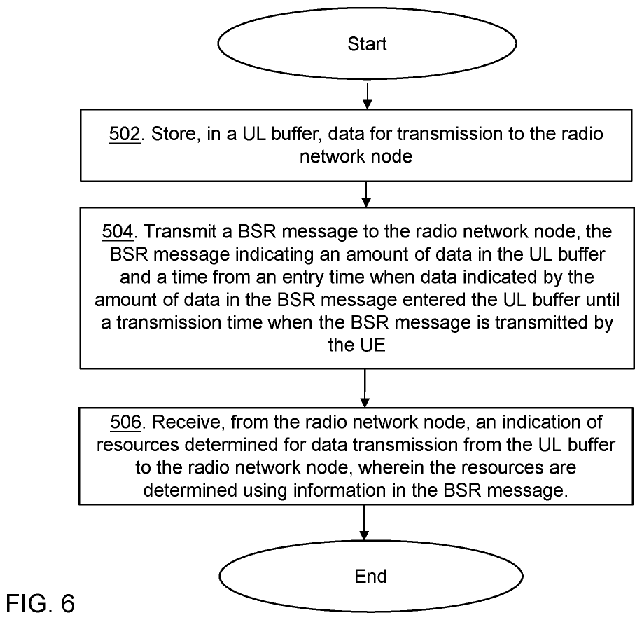

FIG. 6 is a flowchart additionally illustrating a method performed by a UE, such as the UE 10′, according to some embodiments herein. The process shown in FIG. 6 comprises the following actions, which may be taken in any suitable order.

Action 502. The UE 10′ stores, in a UL buffer of the UE 10′ data for transmission to the radio network node. The UL buffer may comprise more than one transmit buffers. Action 504. The UE 10′ transmits a BSR message to the radio network node 12, the BSR message indicating an amount of data in the UL buffer and a time from an entry time when data indicated by the amount of data in the BSR message entered the UL buffer of the UE until a transmission time when the BSR message is transmitted by the UE. The BSR message is thus extended to include, in addition to the amount of data in the UL buffer, information on how long time ago data currently available in the UL buffer, or a portion thereof, entered the UL buffer of the UE.

In some embodiments, the BSR message includes an additional field indicating a time, such as, e.g., the time from an entry time when data indicated by the amount of data in the BSR message entered the UL buffer of the UE until a transmission time when the BSR message is transmitted by the UE. The additional field may have any suitable size and format. The time may comprise an age of an oldest packet in the UL buffer of the UE. The age of the oldest packet in the UL buffer may be indicated in the additional field of the BSR message per a logical channel or a logical channel group.

In some cases, the time indicated in the BSR message may be derived from a packet arrival on a chip set or modem level of the UE. For example, the UE may store the current system time at which a data packet arrived in the UE. In some examples, the “arrival time” may be provided and passed to the chipset or modem by the application that generated the data and may thereby allow determining the actual age of the data more accurately. Upon generating a BSR, the UE computes the difference between the (new) current system time and the stored arrival time of the oldest queued packet and includes this difference into the BSR. The determined time difference may be rounded or quantized in a predetermined way (e.g. finer granularity for smaller latency values than for larger latency values) to require fewer bits in the BSR message.

In some cases, instead of reporting the age of the packet (i.e. a difference between packet arrival and transmission of the BSR) in the BSR, the UE may also include an absolute time in the BSR. This may be the time when the packet arrived on the chipset or modem level or when the application generated it. Alternatively, it may be the “due time”, i.e., the latest time by which the UE should have transmitted the data to meet the packets QoS requirements. An absolute time stamp may be defined as a global time such as Coordinated Universal Time (UTC) or the system time of the radio interface. The latter may be a system frame number (SFN), or a slot number, or a combination of both. To reduce the required number of bits in the BSR, the time format may be truncated such that the least and/or most significant bits of the UTC, SFN/slot-number are not transmitted in the BSR.

In some embodiments, the age of the oldest packet in the UL buffer is indicated in the additional field of the BSR message as an SFN of a time at which the oldest packet arrived in the UL buffer of the UE. In some embodiments, the additional field of the of the BSR message includes a certain number of least significant bits of the SFN that is smaller than all bits of the SFN, and the radio network node 12 determines the full SFN.

The time from an entry time when data indicated by the amount of data in the BSR message entered the UL buffer of the UE until a transmission time when the BSR message is transmitted by the UE may be determined in various ways at the radio network node 12. For example, the time indicated in the BSR may be derived from a time when one or more packets arrive on a chip set/modem level of the UE 10′. As another example, the time indicated in the BSR may be provided by an application.

Action 506. The UE 10′ receives, from the radio network node 12, an indication of resources determined for data transmission from the UL buffer to the radio network node, wherein the resources are determined using information in the BSR message. The indication may be a UL grant to the UE 10′.

In some embodiments, the UE 10′ requests additional information from the radio network node 12, when the radio network node 12 instructs the UE 10′ when and how to send UL data from the UL buffer. For example, it may be required that more robust encoding is used for transmission and/or retransmission.

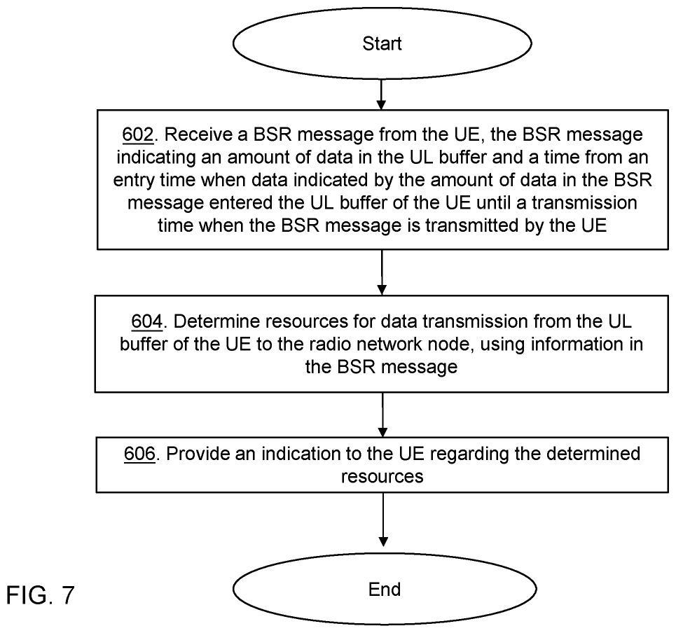

FIG. 7 is a flowchart illustrating a method performed by a radio network node, such as the radio network node 12, according to some embodiments herein. The process shown in FIG. 7 comprises the following actions, which may be taken in any suitable order.

Action 602. The radio network node 12 receives a BSR message from the UE 10′, the BSR message indicating an amount of data in a UL buffer of the UE and a time from an entry time when data indicated by the amount of data in the BSR message entered the UL buffer of the UE until a transmission time when the BSR message is transmitted by the UE.

Action 604. The radio network node 12 determines resources for data transmission from the UL buffer of the UE to the radio network node, wherein the resources are determined using information in the BSR message. For example, as discussed above, the radio network node uses a timestamp, or age, included in the BSR to update the oldest entry of its age map. When taking the scheduling decision for the next UL slot, the radio network node may compare the timestamps/ages of the oldest age map entries of all UEs and assign radio resources to one or more UE with the oldest data in the UL buffer. In some cases, the radio network node may assign resources to a UE that is closest to a configured maximum delay budget.

Action 606. The radio network node 12 provides to the UE an indication of the determined, or allocated resources. The indication may be an UL grant.

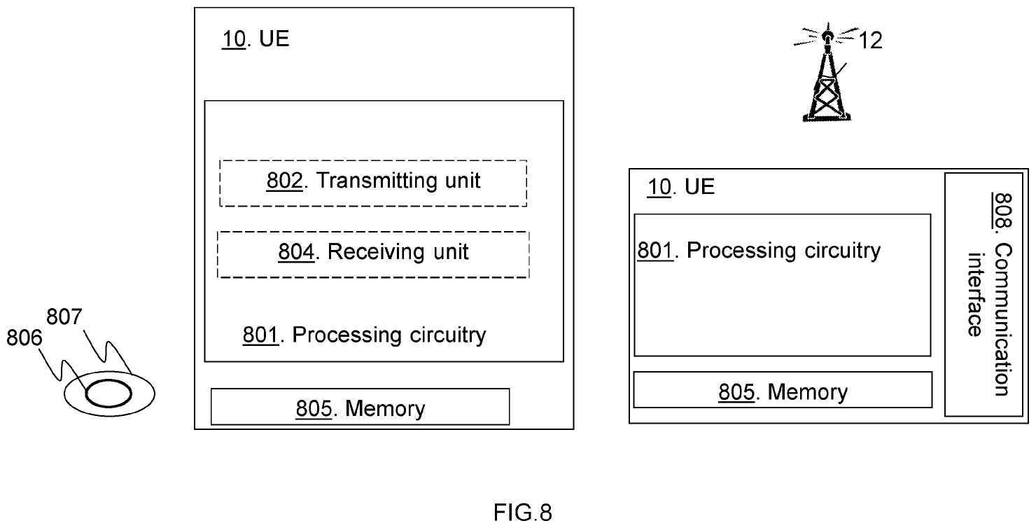

FIG. 8 is a block diagram depicting a UE, such as the UE 10 or UE 10′, collectively referred to herein as the UE 10, in embodiments for handling communications in the wireless communications network 1 according to embodiments herein. The UEs communicate with a radio network node, such as the radio network node 12, in a wireless communication network 1.

The UE 10 may comprise processing circuitry 801, e.g. one or more processors, configured to perform the methods herein.

The UE 10 may comprise a transmitting unit 802, e.g. a receiver or transceiver. The UE 10, the processing circuitry 801, and/or the transmitting unit 802 may be configured to transmit, to the radio network node 12, a BSR message indicating an amount of data in a UL buffer of the UE 10. In some aspects, the BSR message is extended to include, in addition to the indication of the amount of data in the UL buffer of the UE 10, a time from an entry time when data indicated by the amount of data in the BSR message entered the UL buffer of the UE until a transmission time when the BSR message is transmitted by the UE.

The BSR message may include an additional field indicating a time from an entry time when data indicated by the amount of data indicated in the BSR message entered the UL buffer of the UE until a transmission time when the BSR message is transmitted by the UE. The indicated time may comprise an age of an oldest packet in the UL buffer of the UE. The age of the oldest packet in the UL buffer may be indicated in the additional field of the BSR message per a logical channel or a logical channel group.

In some embodiments, the age of the oldest packet in the UL buffer is indicated in the additional field of the BSR message as a system frame number (SFN) of a time at which the oldest packet arrived in the UL buffer of the UE. In some embodiments, the additional field of the of the BSR message includes a certain number of least significant bits of the SFN that is smaller than all bits of the SFN, and the radio network node 12 determines the full SFN.

The time between a time when data entered the UL buffer and a time of transmission of the BSR message may be determined in various ways at the radio network node 12. For example, the time indicated in the BSR message may be derived from a time when one or more packets arrive on a chip set/modem level of the UE 10′. As another example, the time indicated in the BSR message may be provided by an application.

As shown in FIG. 8, the UE 10 may comprise a receiving unit 804, e.g. a receiver or transceiver. The UE 10, the processing circuitry 801, and/or the receiving unit 804 may be configured to receive, from the radio network node 12, an indication of resources determined for data transmission from the UL buffer of the UE 10 to the radio network node 12. The UE 10, the processing circuitry 801, and/or the receiving unit 804 may be configured to receive, from the radio network node 12 may be configured to receive a UL grant from the radio network node, the UL grant indicating the resources determined for data transmission from the UL buffer of the UE 10 to the radio network node 12. In some embodiments, the resources are determined using an age map created and maintained at the radio network node 12 as described above in connection with FIGS. 2, 3A-3B, and 4A-4E. In some embodiments, additionally or alternatively, the UE 10 may receive, from the radio network node 12, an indication regarding resources determined for data transmission from the UL buffer of the UE to the radio network node, wherein the resources are determined using information in the BSR message that is extended as described above in connection with FIGS. 5, 6, and 7.

The UE 10, the processing circuitry 801, and/or the transmitting unit 802 are configured to transmit data from the UL buffer of the UE using the determined resources indicated to the UE by the radio network node.

The UE 10 may comprise a memory 805. The memory 805 comprises one or more units to be used to store data on, such as data packets, thresholds, signal strengths/qualities, measurements, multilevel ACK/NACKs definitions, events and applications to perform the methods disclosed herein when being executed, and similar. The memory 805 may store one or more UL buffers including data available for transmission to the radio network node 12.

Furthermore, the UE 10 may comprise a communication interface 808 such as comprising a transmitter, a receiver, a transceiver and/or one or more antennas.

The methods according to the embodiments described herein for the UE 10 are respectively implemented by means of e.g. a computer program product 806 or a computer program, comprising instructions, i.e., software code portions, which, when executed on at least one processor, cause the at least one processor to carry out the actions described herein, as performed by the UE 10. The computer program product 906 may be stored on a computer-readable storage medium 807, e.g. a disc, a universal serial bus (USB) stick or similar. The computer-readable storage medium 807, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

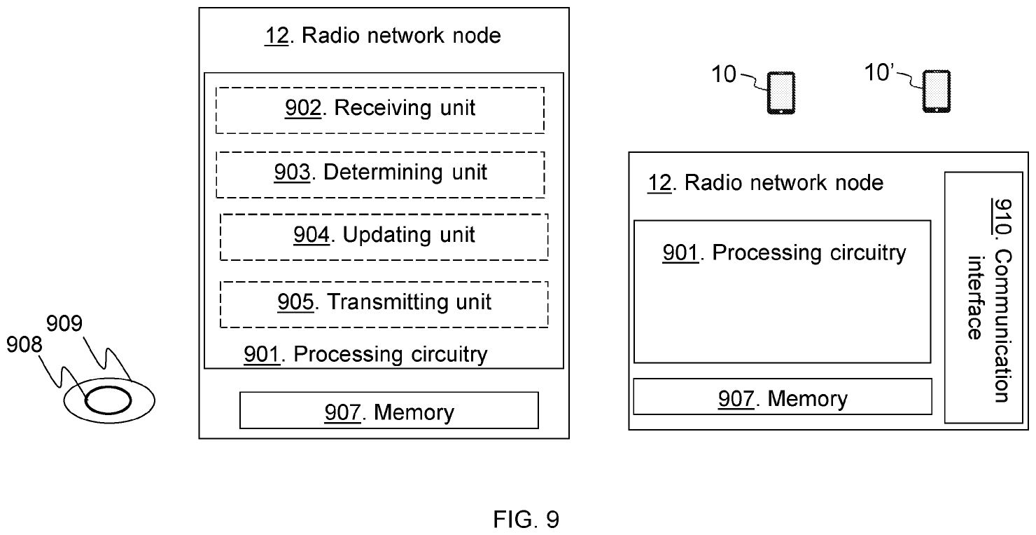

FIG. 9 is a block diagram depicting the radio network node 12 in embodiments for handling communications in the wireless communications network 1 according to embodiments herein. The radio network node 12 may communicate with UEs such that the UE 10 and UE 10′, collectively referred to herein as the UE 10, for description purposes only.

The radio network node 12 may comprise processing circuitry 901, e.g. one or more processors, configured to perform the methods herein.

The radio network node 12 may comprise a receiving unit 902. The radio network node 12, the processing circuitry 901, and/or the receiving unit 902 are configured to receive a BSR message indicating a current amount of data buffered in a UL buffer of the UE. In some aspects, the BSR message is extended to include, in addition to an indication of the current amount of data in the UL buffer of the UE 10, a time from an entry time when data indicated by the current amount of data indicated in the BSR message entered the UL buffer of the UE until a transmission time when the BSR message is transmitted by the UE. The time from the entry time until the BSR transmission time may be an age of the oldest packet in the UL buffer, or queue, of the UE 10.

In some embodiments, the BSR message further indicates an amount of data that was dropped from the UL buffer of the UE compared to a time of transmittal of a prior BSR message.

The radio network node 12, the processing circuitry 901, and/or the receiving unit 902 are configured to receive a certain amount of UL data from the UE, according to a grant to the UE sent to the UE by the radio network node.

The radio network node 12 may comprise a determining unit 903. The radio network node 12, the processing circuitry 901, and/or the determining unit 903 are configured to determine whether to update an age map for the logical channel of the radio network node by determining a difference between the current amount of data indicated in the BSR message and a sum of data values stored in the age map for the logical channel of the radio network node, wherein each entry in the age map includes a data value and an associated timestamp, the associated timestamp indicating an estimated arrival time of data corresponding to the data value to the UL buffer.

The radio network node 12, the processing circuitry 901, and/or the determining unit 903 may be configured to determine a difference between the current amount of data indicated in the BSR message and the sum of data values stored in the age map for a logical channel or a logical channel group of the radio network node. The sum of the data values stored in the age map is a sum of data values in all current entries in the age map. The age map may include one or more marked or flagged entries, which indicate data for which a UL grant has been issued; and the flagged entries are considered when determining the sum of all data values in the age map.

The difference between the current amount of data indicated in the BSR message and the sum of data values stored in the age map may be a positive value, a negative value, or a zero i.e. no difference. If the difference is zero, no new entry is created in the age map since the BSR message indicates that no new data has been stored in the UL buffer of the UE 10 since the receipt of a prior, most recent BSR message by the radio network node 12.

If the difference between the current amount of data, as indicated in the BSR message, and the sum of data values stored in the age map is a positive or negative value, the radio network node 12 updates the age map.

The radio network node 12, the processing circuitry 901, and/or the determining unit 903 may be configured to, after the radio network node 12 receives the certain amount of UL data from the UE according to the grant to the UE, remove or update at least one entry in the age map such that the sum of data values stored in the age map is decreased in accordance with the certain amount of data received from the UE, wherein the at least one entry in the age map comprises an entry with an oldest timestamp.

The radio network node 12, the processing circuitry 901, and/or the determining unit 903 may be configured to determine resources for data transmission from the UL buffer of the UE to the radio network node, wherein the resources are determined using information in the BSR message. The BSR message may indicate an amount of data in the UL buffer and a time from an entry time when data indicated by the amount of data in the BSR message entered the UL buffer of the UE until a transmission time when the BSR message is transmitted by the UE.

The radio network node 12 may comprise an updating unit 904. The radio network node 12, the processing circuitry 901, and/or the updating unit 904 may be configured to, if the difference is a positive value, add a new entry to the age map, the new entry having a timestamp corresponding to a time of receipt of the BSR message and a data value corresponding to the difference.

In some examples, the timestamp corresponding to a time of receipt of the BSR message comprises an estimated arrival time to the UL buffer of the UE of data corresponding to the difference.

In some examples, the timestamp corresponding to a time of receipt of the BSR message comprises any one of:
a current time, i.e., the time of receipt of the BSR message by the radio network node 12;
the current time minus an offset accounting for a time from an arrival to the UL buffer of the UE of data corresponding to the new entry until the time of receipt of the BSR message; and
a due time for the UE to transmit the data corresponding to the new entry to the age map.

Thus, the radio network node 12, the processing circuitry 901, and/or the updating unit 904 may be configured to, if the difference is a negative value, remove or update at least one entry in the age map such that the sum of data values stored in the age map is decreased in accordance with the difference. The difference may be negative because of, e.g., a finer granularity of the BSR message reporting for a UE's UL buffer of a smaller size such that the UE reports, in the BSR message, less data than is actually accumulated in the UL buffer. In some cases, the UE may receive a UL grant and may report in the BSR message less data than is currently in the UL buffer, since the UE has not sent the data yet for which the UL grant was received.

In some cases, the difference is a negative value because of a coarse granularity of the BSR message such that prior BSR message(s) caused the radio network node 12 to account for more data than was actually in the UL buffer of the UE.

The radio network node 12, the processing circuitry 901, and/or the updating unit 904 may be configured to remove or update the at least one entry in the age map that comprises an entry with a newest timestamp.

In some cases, the difference is a negative value because of dropped packets at the UE, which are typically the oldest packets. Thus, the UL buffer of the UE may include less data than the radio network node 12 expects it to have based on information in the age map.

In some examples, the radio network node 12, the processing circuitry 901, and/or the updating unit 904 may be configured to remove or update the at least one entry in the age map that comprises an entry with an oldest timestamp, which may be referred to as an oldest entry corresponding to at least one oldest packet. It may be considered that the oldest packet(s) are more likely to be sent from the UL buffer of the UE.

The radio network node 12, the processing circuitry 901, and/or the updating unit 904 may be configured to, when the radio network node 12 has received a certain amount of data from the UE 10, remove or update at least one entry in the age map such that the sum of data values stored in the age map is decreased in accordance with the certain amount of data in the grant. In this case, the at least one entry in the age map may comprise an entry with an oldest timestamp.

The radio network node 12, the processing circuitry 901, and/or the updating unit 904 may be configured to:
after indicating the determined resources as the grant to the UE comprising resources for the certain amount of data in the UL buffer of the UE for transmission to the radio network node, and before receiving the certain amount of UL data from the UE,
   remove or update at least one entry in the age map such that the sum of data values stored in the age map is decreased in accordance with the certain amount of data in the grant, wherein the at least one entry in the age map comprises an entry with an oldest timestamp;
add at least one flagged entry to the age map with the oldest timestamp and indicating the certain amount of data for which the resources are included in the grant and, the at least one flagged entry being associated with an indicator indicating that a grant for the certain amount of data indicated in the at least one flagged entry in the age map has already been given to the UE.

In aspects in which the BSR message is extended to further indicate a time from an entry time when data indicated by the current amount of data indicated in the BSR message entered the UL buffer of the UE until a transmission time when the BSR message is transmitted by the UE, the radio network node 12, the processing circuitry 901, and/or the updating unit 904 may be configured to update a timestamp of an oldest entry in the age map by replacing the timestamp of the oldest entry with the age of the oldest packet in the UL buffer, wherein the age of the oldest packet in the UL buffer is received in the BSR message. This allows managing the age map in a manner that accounts for packets dropped at the UE 10.

The radio network node 12 may comprise a transmitting unit 905, e.g. a receiver or transceiver. The radio network node 12, the processing circuitry 901, and/or the determining unit 903, and/or the transmitting unit 905 are configured to use the age map to determine resources for data transmission from the UL buffer to the radio network node and indicate the determined resources to the UE. The resources may be indicated, e.g., in a UL grant.

The radio network node 12, the processing circuitry 901, and/or the determining unit 903, and/or the transmitting unit 905 may be configured to indicate the determined resources as a grant to the UE 10 comprising resources for a certain amount of data in the UL buffer of the UE for transmission to the radio network node 12. The grant, such as a UL grant, may be provided by the UE as part of using the age map to determine the resources for data transmission from the UL buffer to the radio network node and indicating the determined resources to the UE.

The radio network node 12, the processing circuitry 901, and/or the determining unit 903, and/or the transmitting unit 905 may be configured to indicate the determined resources as a subsequent grant to the UE comprising resources for a certain second amount of data in the UL buffer of the UE for transmission to the radio network node. Using the age map to determine the resources as the subsequent grant to the UE may comprise taking into consideration one or more entries in the age map other than the at least one flagged entry.

In aspects in which the BSR is extended indicate a time from an entry time when data indicated by the amount of data in the BSR message entered the UL buffer of the UE until a transmission time when the BSR message is transmitted by the UE, the radio network node 12, the processing circuitry 901, and/or the transmitting unit 905 are configured to provide to the UE an indication of determined resources. The indication may be an UL grant.

The radio network node 12 may comprise a memory 907. The memory 907 comprises one or more units to be used to store data on, such as data packets, ACK/NACK configurations, settings, multilevel ACKs/NACKs, allocated resources, thresholds, events and applications to perform the methods disclosed herein when being executed, and similar. The memory 907 may store an age map in accordance with aspects of the present disclosure.

Furthermore, the radio network node may comprise a communication interface 910 such as comprising a transmitter, a receiver, a transceiver and/or one or more antennas.

The methods according to the embodiments described herein for the radio network node 12 are respectively implemented by means of e.g. a computer program product 908 or a computer program, comprising instructions, i.e., software code portions, which, when executed on at least one processor, cause the at least one processor to carry out the actions described herein, as performed by the radio network node 12. The computer program product 908 may be stored on a computer-readable storage medium 909, e.g. a disc, a universal serial bus (USB) stick or similar. The computer-readable storage medium 909, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose the radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

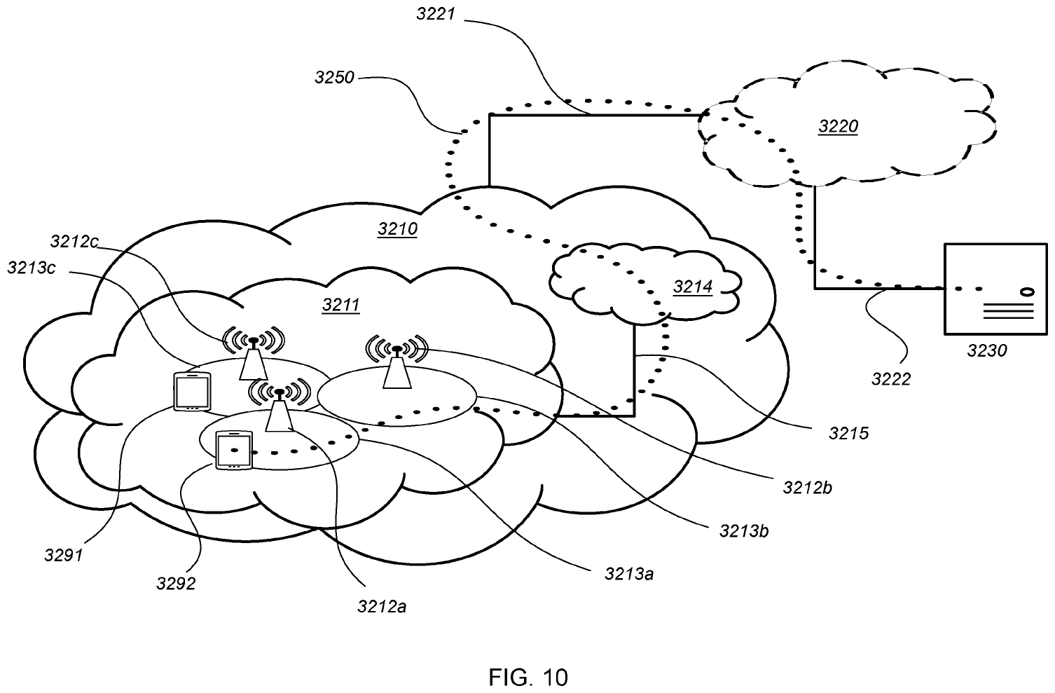

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

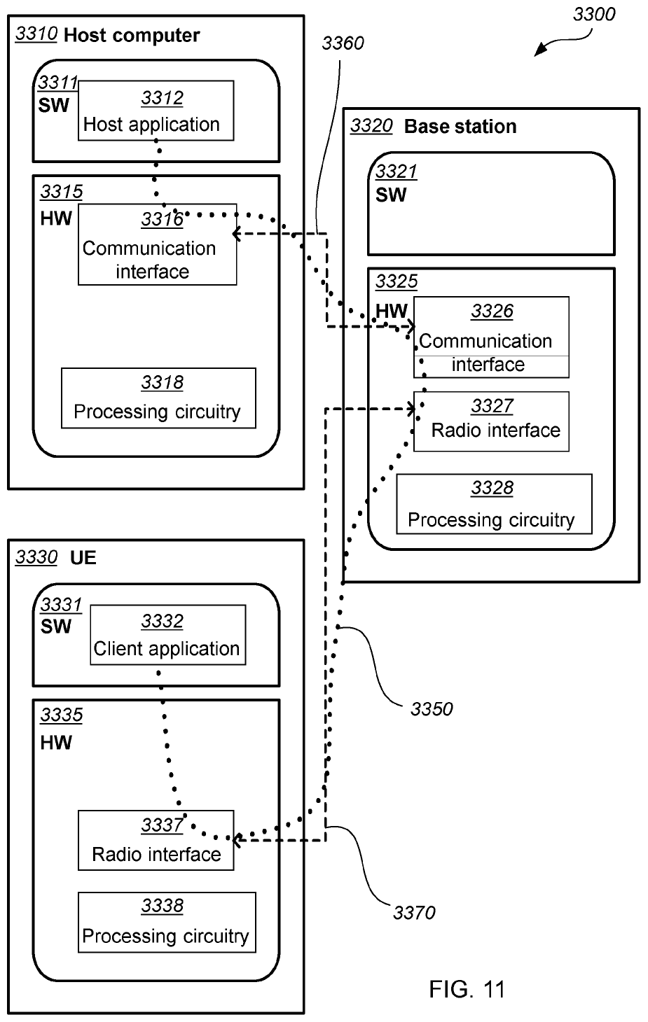

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 11, respectively. This is to say, the inner workings of these entities may be as shown in FIG. 11 and independently, the surrounding network topology may be that of FIG. 11.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since radio resource may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

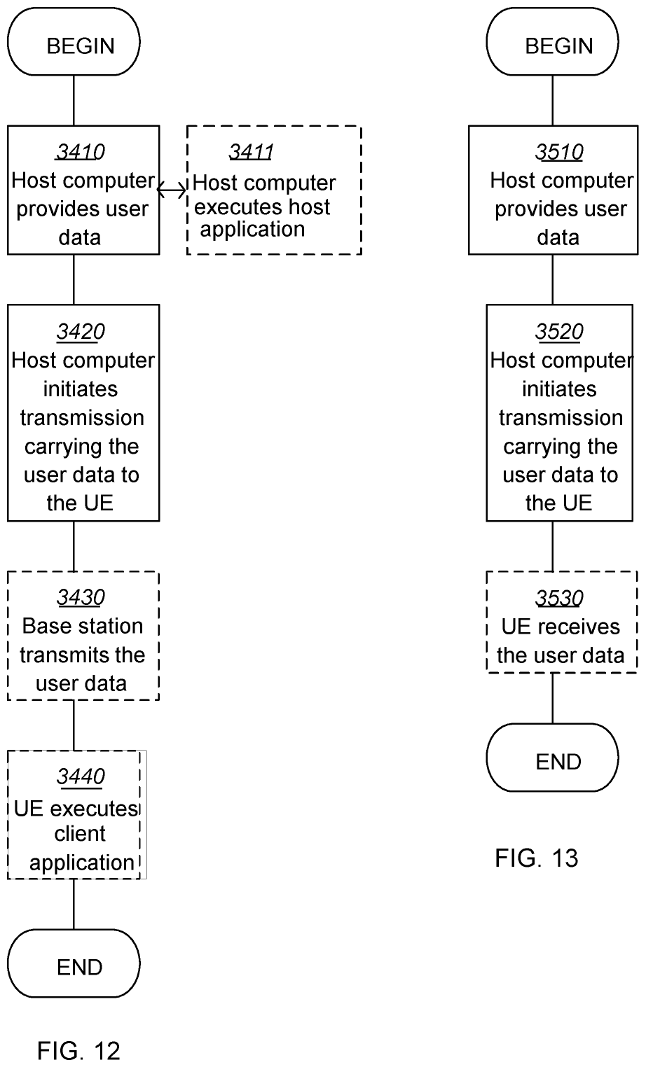

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

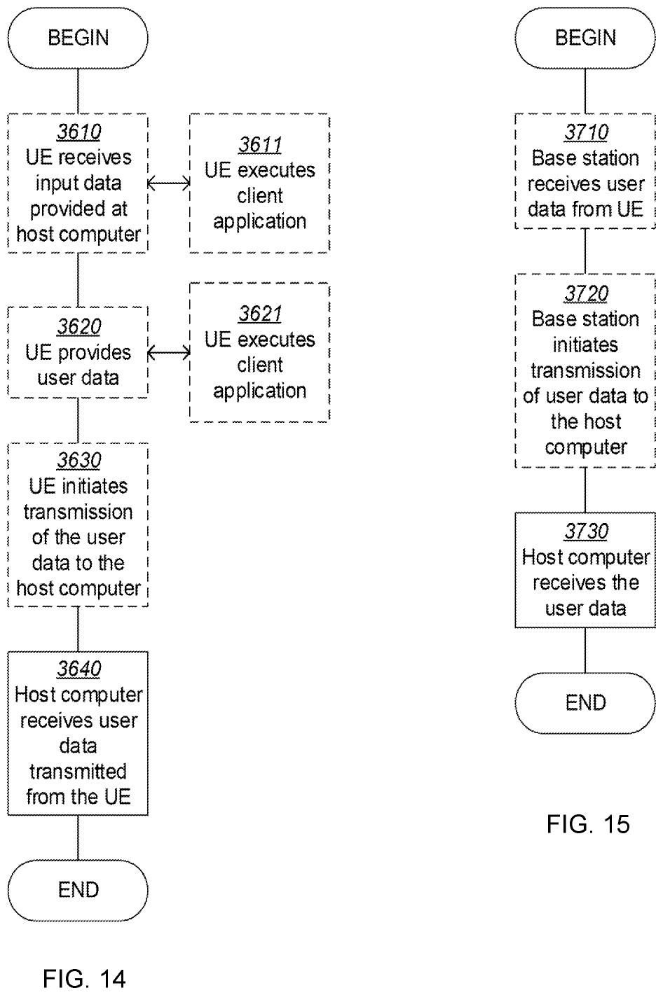

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It should be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams Include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a radio network node for communication with a user equipment, UE, in a wireless communications network, the method comprising:
receiving a buffer status report, BSR, message from the UE, the BSR message indicating a current amount of data buffered in an uplink, UL, buffer of the UE for a logical channel;
determining whether to update an age map for the logical channel of the radio network node by determining a difference between the current amount of data indicated in the BSR message and a sum of data values stored in the age map for the logical channel of the radio network node, wherein each entry in the age map includes including a data value and an associated timestamp, the associated timestamp indicating an estimated arrival time of data corresponding to the data value to the UL buffer;
with the proviso that the difference is a positive value, adding a new entry to the age map, the new entry having a timestamp corresponding to a time of receipt of the BSR message and a data value corresponding to the difference; and
using the age map to determine resources for data transmission from the UL buffer to the radio network node and indicating the determined resources to the UE.

2. The method of claim 1, further comprising:
with the proviso that the difference is a negative value, removing or updating at least one entry in the age map such that the sum of data values stored in the age map is decreased in accordance with the difference.

3. The method of claim 2, wherein removing or updating the at least one entry in the age map comprises removing or updating an entry with a newest timestamp.

4. The method of claim 2, wherein removing or updating the at least one entry in the age map comprises removing or updating an entry with an oldest timestamp.

5. The method of claim 1, further comprising:
indicating the determined resources as a grant to the UE comprising resources for a certain amount of data in the UL buffer of the UE for transmission to the radio network node.

6. The method of claim 5, further comprising:
receiving the certain amount of UL data from the UE, according to the grant to the UE; and
removing or updating at least one entry in the age map such that the sum of data values stored in the age map is decreased in accordance with the certain amount of data received from the UE, wherein the at least one entry in the age map comprises an entry with an oldest timestamp.

7. The method of claim 5, further comprising:
after indicating the determined resources as the grant to the UE comprising resources for the certain amount of data in the UL buffer of the UE for transmission to the radio network node, and before receiving the certain amount of UL data from the UE, removing or updating at least one entry in the age map such that the sum of data values stored in the age map is decreased in accordance with the certain amount of data in the grant, wherein the at least one entry in the age map comprises an entry with an oldest timestamp; and
adding at least one flagged entry to the age map with the oldest timestamp and indicating the certain amount of data for which the resources are included in the grant and, the at least one flagged entry being associated with an indicator indicating that a grant for the certain amount of data indicated in the at least one flagged entry in the age map has already been given to the UE.

8. The method of claim 7, further comprising:
indicating the determined resources as a subsequent grant to the UE comprising resources for a certain second amount of data in the UL buffer of the UE for transmission to the radio network node, wherein using the age map to determine the resources as the subsequent grant to the UE comprises taking into consideration one or more entries in the age map other than the at least one flagged entry.

9. The method of claim 1, wherein the timestamp corresponding to the time of receipt of the BSR message comprises an estimated arrival time to the UL buffer of the UE of data corresponding to the difference.

10. The method of claim 1, wherein the timestamp corresponding to the time of receipt of the BSR message comprises any one of:
a current time;
the current time minus an offset accounting for a time from an arrival to the UL buffer of the UE of data corresponding to the new entry until the time of receipt of the BSR message; and
a due time for the UE to transmit the data corresponding to the new entry to the age map;
and one or more of:
the BSR message further indicates an amount of data that was dropped from the UL buffer of the UE compared to a time of transmittal of a prior BSR message;
the BSR message further indicates a time from an entry time when data indicated by the current amount of data in the BSR message entered the UL buffer of the UE until a transmission time when the BSR message is transmitted by the UE;
the BSR message includes an additional field indicating the time, the time comprising an age of an oldest packet in the UL buffer of the UE;
the age of the oldest packet is indicated in the additional field of the BSR message as a system frame number, SFN, of a time at which the oldest packet arrived in the UL buffer of the UE; and
the additional field of BSR message includes a certain number of least significant bits of the SFN that is smaller than a number of all bits of the SFN.

11.-20. (canceled)

21. A radio network node configured for communication with a user equipment, UE, in a wireless communications network, the radio network node being configured to:
receive a buffer status report, BSR, message from the UE, the BSR message indicating a current amount of data buffered in an UL buffer of the UE for a logical channel;
determine whether to update an age map for the logical channel of the radio network node by determining a difference between the current amount of data indicated in the BSR message and a sum of data values stored in an age map for the logical channel of the radio network node, each entry in the age map including a data value and associated timestamp, the associated timestamp indicating an estimated arrival time of data corresponding to the data value to the UL buffer;
with the proviso that the difference is a positive value, add a new entry to the age map, the new entry having a timestamp corresponding to a time of receipt of the BSR message and a data value corresponding to the difference; and
use the age map to determine resources for data transmission from the UL buffer to the radio network node and indicate the determined resources to the UE.

22. The radio network node of claim 21, further configured to:
with the proviso that the difference is a negative value, remove or update at least one entry in the age map such that the sum of data values stored in the age map is decreased in accordance with the difference.

23. The radio network node of claim 22, further configured to remove or update the at least one entry in the age map that comprises an entry with a newest timestamp.

24. The radio network node of claim 22, further configured to remove or update the at least one entry in the age map that comprises an entry with an oldest timestamp.

25. The radio network node of claim 21, further configured to:
indicate the determined resources as a grant to the UE comprising resources for a certain amount of data in the UL buffer of the UE for transmission to the radio network node.

26. The radio network node of claim 25, further configured to:
receive the certain amount of UL data from the UE, according to the grant to the UE; and
remove or update at least one entry in the age map such that the sum of data values stored in the age map is decreased in accordance with the certain amount of data received from the UE, wherein the at least one entry in the age map comprises an entry with an oldest timestamp.

27.-38. (canceled)

39. A method performed by a user equipment, UE, for communication with a radio network node in a wireless communications network, the method comprising:
storing, in an uplink, UL, buffer of the UE, data for transmission to the radio network node;
transmitting a buffer status report, BSR, message to the radio network node, the BSR message indicating an amount of data in the UL buffer and a time from an entry time when data indicated by the amount of data in the BSR message entered the UL buffer of the UE until a transmission time when the BSR message is transmitted by the UE; and
receiving, from the radio network node, an indication of resources determined for data transmission from the UL buffer to the radio network node, the resources being determined using information in the BSR message.

40. The method of claim 39, wherein the BSR message is extended to include an additional field indicating the time.

41. The method of claim 40, wherein the additional field comprises an age of an oldest packet in the UL buffer of the UE.

42.-56. (canceled)

57. A user equipment, UE, configured for communication with a radio network node in a wireless communications network, the UE being configured to:
store, in an uplink, UL, buffer of the UE, data for transmission to the radio network node;
transmit a buffer status report, BSR, message to the radio network node, the BSR message indicating an amount of data in the UL buffer and a time from an entry time when data indicated by the amount of data in the BSR message entered the UL buffer of the UE until a transmission time when the BSR message is transmitted by the UE; and
receive, from the radio network node, an indication of resources determined for data transmission from the UL buffer to the radio network node, the resources being determined using information in the BSR message.

58. (canceled)
